(19) United States
(12) Patent Application Publication
(10) Pub. No.: US 2012/0329449 A1
(43) Pub. Date: Dec. 27, 2012

(54) SYSTEMS AND METHODS PROVIDING CONTINUED SUBSCRIBER SERVICES WITH INTER-RAT (RADIO ACCESS TECHNOLOGY) NETWORK ENERGY SAVINGS

(75) Inventors: Soumya Das, San Diego, CA (US); Bongyong Song, San Diego, CA (US); Vikram B. Yerrabommanahalli, Sunnyvale, CA (US); Samir S. Soliman, San Diego, CA (US)

(73) Assignee: QUALCOMM Incorporated, San Diego, CA (US)

(21) Appl. No.: 13/167,198

(22) Filed: Jun. 23, 2011

(51) Int. Cl. H04W 24/00; H04W 40/00

(52) U.S. Cl. 455/423; 455/445

(57) ABSTRACT

Techniques for providing continued subscriber services while facilitating network energy savings through the use of inter-RAT energy savings schemes are described. Network energy savings may use inter-RAT energy savings schemes adapted to mitigate the effect of gaps in service area coverage and thus enable continued wireless communication services. Network energy savings intelligence may operate to extend intra-RAT energy saving frameworks to inter-RAT energy savings frameworks by facilitating selection of network resources for implementation of energy savings techniques, adjustment of network resources for optimizing service area coverage during implementation of energy savings techniques, making determinations regarding when aspects of an energy savings technique are to be invoked or exited. Network energy savings intelligence may be utilized to facilitate service continuity with respect to particular services, such as by capturing requests for particular services, which might otherwise be unavailable due to implementation of an energy savings technique.

### CROSS-REFERENCE TO RELATED APPLICATIONS

The present application is related to co-pending and commonly assigned U.S. patent application Ser. No. 13/070,398 entitled “Cellular Network Energy Saving,” filed Mar. 23, 2011, the disclosure of which is hereby incorporated herein by reference.

### BACKGROUND

1. Field

The disclosure relates generally to wireless communications and, more particularly, to providing continued subscriber services while facilitating network energy savings through the use of inter-RAT energy savings schemes.

2. Background

The use of wireless communication systems in providing both voice and data communications has become widespread. In industrialized countries wireless communication networks are commonly utilized for mobile telephony, mobile broadband data services, location and tracking services, etc. In developing countries wireless communication networks have been used to deliver communication services where traditional wireline infrastructure has not been deployed or has otherwise been underdeveloped. Accordingly, wireless communication networks, such as cellular networks operable in accordance with Global System for Mobile (GSM), Code Division Multiple Access (CDMA), (CDMA) 1x Evolution (CDMA 1x), CDMA 1x Data Optimized (CDMA 1x-EV-DO) (also known as High Rate Packet Data (HRPD)), Universal Mobile Telecommunications System (UMTS), 3^{rd} Generation Partnership Project 2 (3GPP2), 3^{rd} Generation Mobile Telecommunications (3G), 4^{th} Generation Mobile Telecommunications (4G), 3GPP Long Term Evolution (LTE), etc., have been or are being deployed around the world.

Operation of wireless communication infrastructure often consumes relatively large amounts of energy which can have a significant impact upon the environment. For example, base stations providing wireless communication infrastructure in networks such as the foregoing cellular telephone and data networks often consume a large amount of power, generally accounting for approximately 80% of a network's total energy consumption. In many areas (e.g., rural areas, underdeveloped countries, etc.) base station equipment and other wireless communication infrastructure is powered by electric generation systems employing internal combustion engines (e.g., diesel generator sets) which can be expensive to operate and a significant source of carbon emissions. It has been estimated that in 2007 Information and Communication Technologies (ICT), including mobiles, fixed telecoms, PCs etc., contributed approximately 2% of the global CO₂ emissions. Moreover, diesel power generation is typically more expensive than traditional sources of electricity through the electrical grid. The GSM Association (GSMA) estimates that the annual diesel bill accrued by wireless communication network operators in developing nations will hit $14.6 billion by 2012.

Reducing the amount of energy consumed in operating wireless communication infrastructure can significantly impact a network operator's operational expenditure (OPEX). For example, a 1% reduction in power consumption can save $12.2M per year according to one Asian wireless communication network operator. Moreover, in some countries operators are forced to shut off base stations during certain times to save energy and/or cost. Thus, it may be desirable for wireless communication network operators to have an energy savings framework that reduces operational expenditures and provides socially responsible operation by adopting a greener approach.

Recently some initiatives have been undertaken to propose features useful in facilitating wireless communication network energy savings. The 3^{rd} Generation Partnership Project 2 (3GPP2) is currently working on a green initiative to facilitate energy savings within CDMA 1x EV-DO networks, separately, during off-peak periods. As part of the initiative, protocol enhancements are being investigated, whereby infrastructure within a Radio Access Technology (RAT) network is temporarily scaled down, which can potentially reduce network infrastructure energy consumption. Similarly, 3GPP Rel. 9 has an inter-eNodeB network energy saving framework that allows autonomous eNodeB power shut off and which provides for neighboring cells within the RAT network to trigger the eNodeB to power back on.

These intra-RAT energy savings schemes may (e.g., where the intra-RAT energy savings schemes are aggressive) result in coverage holes within the wireless communication network's service area due to the infrastructure (e.g., base stations) within the RAT network being powered/scaled down to conserve energy. In order for the energy savings achieved by these intra-RAT energy savings schemes to be significant, the coverage holes created by turning off infrastructure (e.g., more base stations) are quite large and thus result in degradation of the user experience. Such a result is difficult for wireless communication network operators to accept in the face of stiff competition as subscribers will leave and go to other wireless communication networks offered by different operators, particularly in countries where there is no contract needed for mobile users.

Recently, the standards bodies have begun to address inter-RAT communications, whereby infrastructure of a first RAT may communicate with infrastructure of a second RAT. Included in this initiative are inter-RAT communications protocols, referred to as RAT information management (RIM) protocols, for communicating the operating state of infrastructure (e.g., energy savings operation of a base station), the load experienced by particular infrastructure (e.g., the number of subscribers accessing the network via a particular base station), and requests to change the operating state of infrastructure (e.g., to change from energy savings operation to nominal operation by a base station) between infrastructure of two different RATs. It should be appreciated, however, that such inter-RAT communications protocols themselves do not establish inter-RAT energy saving operations, but instead merely provide an information management protocol. Moreover, the inter-RAT communications protocols do not define energy savings techniques which transition from intra-RAT to inter-RAT energy savings techniques.

### SUMMARY

Various aspects of the present disclosure are directed to wireless communications providing continued subscriber services while facilitating network energy savings through the use of inter-RAT energy savings schemes. Wireless communication network energy savings are facilitated according to aspects herein through the use of inter-RAT energy savings schemes adapted to minimize or mitigate the effect of gaps in service area coverage and thus enable continued wireless communication services. Network energy savings intelligence in accordance with aspects herein operates to extend intra-RAT energy saving frameworks to inter-RAT energy savings frameworks by facilitating selection of network resources (e.g., base stations, carriers, transmitters, receivers, antenna systems, power amplifiers, etc.) for implementation of energy savings techniques, adjustment of network resources for optimizing service area coverage during implementing energy savings techniques, making determinations regarding when aspects of an energy savings technique are to be invoked or exited. Network energy savings intelligence may additionally be utilized according to aspects of the disclosure which facilitate service continuity with respect to particular services during implementation of energy savings techniques, such as by capturing requests for particular services by an access terminal (including, but not limited to, devices also referred to as user equipment, mobile stations, handheld devices, and subscriber equipment), which might otherwise be unavailable due to implementation of an energy savings technique.

In one aspect of the disclosure, a method includes analyzing a performance factor of one or more radio access technology network site. The one or more radio access technology network site is selected from the group consisting of radio access technology network sites of a plurality of sites of a first radio access technology network and radio access technology network sites of a plurality of sites of a second radio access technology network. The method also includes selecting a site of the second radio access technology network as a function of the analyzing for altering operation in accordance with an energy saving technique, and coordinating operation of the first radio access technology network and the second radio access technology network to provide continued wireless communication services within a portion of a service area impacted by energy saving technique operation alteration of the selected second radio access technology network site.

In an additional aspect of the disclosure, a method includes analyzing a performance factor of at least one radio access technology network site. The at least one radio access technology network site is selected from the group consisting of one or more radio access technology network sites of a first radio access technology network and one or more radio access technology network sites of a second radio access technology network. The method also includes selecting a site of the second radio access technology network as a function of the analyzing for altering operation in accordance with an energy saving technique, implementing an energy saving technique at the selected site of the second radio access technology network to place a resource of the selected site in energy savings mode, and coordinating operation of the first radio access technology network and the second radio access technology network to serve an area of the second radio access technology network impacted by implementation of the energy savings mode.

In an additional aspect of the disclosure, a system includes network energy savings intelligence in communication with one or more radio access technology network sites of a first radio access technology network and one or more radio access technology network sites of a second radio access technology network. The network energy savings intelligence is operable to analyze a performance factor of at least one radio access technology network site, to select a site of the second radio access technology network as a function of the analyzing for altering operation in accordance with an energy saving technique, and to coordinate operation of the first radio access technology network and the second radio access technology network to serve an area of the second radio access technology network impacted by implementation of the energy savings technique.

In an additional aspect of the disclosure, a system includes means, in communication with a radio access technology network site of at least one of a first radio access technology network and a second radio access technology network, for analyzing a performance factor of at least one radio access technology network site, means for selecting a site of the second radio access technology network as a function of the analyzing for altering operation in accordance with an energy saving technique, and means, in communication with one or more radio access technology network sites of the first radio access technology network and one or more radio access technology network sites of the second radio access technology network, for coordinating operation of the first radio access technology network and the second radio access technology network to serve an area of the second radio access technology network impacted by implementation of the energy savings technique.

In an additional aspect of the disclosure, a computer program product for wireless communications in a wireless network, includes a computer-readable medium having program code recorded thereon. The program code includes program code to analyze a performance factor of at least one radio access technology network site. The at least one radio access technology network site is selected from the group consisting of one or more radio access technology network sites of a first radio access technology network and one or more radio access technology network sites of a second radio access technology network. The program code also includes program code to select a site of the second radio access technology network as a function of the analyzing for altering operation in accordance with an energy saving technique, program code to initiate implementation of an energy saving technique at the selected site of the second radio access technology network to place a resource of the selected site in energy savings mode, and program code to coordinate operation of the first radio access technology network and the second radio access technology network to serve an area of the second radio access technology network impacted by implementation of the energy savings mode.

In an additional aspect of the disclosure, a method includes capturing a request for a service feature, analyzing services provided by a radio access technology network site of a first radio access technology network for availability of the service feature, and analyzing available communication coverage to determine if services are available from a radio access technology network site of a second radio access technology network. An area of the communication coverage corresponds at least in part to an area of communication coverage of the radio access technology network site of the first radio access technology network. The method also includes initiating communication via the radio access technology network site of the first radio access technology network to request enabling the radio access technology site of the second radio access technology network, and establishing a communication link with the radio access technology network site of the second radio access technology network to obtain the service feature and provide continued communication services within a portion of a service area impacted by energy saving technique operation of the radio access technology network site of the second radio access technology network.

In an additional aspect of the disclosure, a method includes receiving, via a radio access technology site of a first radio access technology network, a request to enable a radio access technology site of a second radio access technology network for providing a service feature not available from the radio access technology site of the first radio access technology network, selecting a radio access technology site of the second radio access technology network for providing the service feature, and coordinating operation of the first radio access technology network and the second radio access technology network to provide continued wireless communication services for the service feature within at least a portion of a communication coverage area of the radio access technology site of the second radio access technology network.

In an additional aspect of the disclosure, a system including an instruction set operable upon a wireless communication system access terminal. The instruction set is operable to capture a request for a service feature, initiate a determination regarding the requested service being provided by a radio access technology network site of a first radio access technology network, and initiate a determination regarding communication coverage by a radio access technology network site of a second radio access technology network. An area of the communication coverage corresponds at least in part to an area of communication coverage of the radio access technology network site of the first radio access technology network. The instruction set is further operable to initiate communication via the radio access technology network site of the first radio access technology network to request enabling the radio access technology site of the second radio access technology network, and initiate establishing a communication link with the radio access technology network site of the second radio access technology network to obtain the service feature and provide continued communication services within a portion of a service area impacted by energy saving technique operation of the radio access technology network site of the second radio access technology network.

In an additional aspect of the disclosure, a system including network energy savings intelligence. The network energy savings intelligence is operable to receive, via a radio access technology site of a first radio access technology network, a request to enable a radio access technology site of a second radio access technology network for providing a service feature not available from the radio access technology site of the first radio access technology network, select a radio access technology site of the second radio access technology network for providing the service feature, and coordinate operation of the first radio access technology network and the second radio access technology network to provide continued wireless communication services for the service feature within at least a portion of a communication coverage area of the radio access technology site of the second radio access technology network.

In an additional aspect of the disclosure, a system includes means for capturing a request for a service feature, means for analyzing services provided by a radio access technology network site of a first radio access technology network for availability of the service feature, and means for analyzing available communication coverage to determine if services are available from a radio access technology network site of a second radio access technology network. An area of the communication coverage corresponds at least in part to an area of communication coverage of the radio access technology network site of the first radio access technology network. The system further includes means for initiating communication via the radio access technology network site of the first radio access technology network to request enabling the radio access technology site of the second radio access technology network, and

means for establishing a communication link with the radio access technology network site of the second radio access technology network to obtain the service feature and provide continued communication services within a portion of a service area impacted by energy saving technique operation of the radio access technology network site of the second radio access technology network.

In an additional aspect of the disclosure, a system includes means for receiving, via a radio access technology site of a first radio access technology network, a request to enable a radio access technology site of a second radio access technology network for providing a service feature not available from the radio access technology site of the first radio access technology network, means for selecting a radio access technology site of the second radio access technology network for providing the service feature, and means for coordinating operation of the first radio access technology network and the second radio access technology network to provide continued wireless communication services for the service feature within at least a portion of a communication coverage area of the radio access technology site of the second radio access technology network.

In an additional aspect of the disclosure, a computer program product for wireless communications in a wireless network, includes a computer-readable medium having program code recorded thereon. The program code includes program code to capture a request for a service feature, program code to initiate a determination regarding the requested service being provided by a radio access technology network site of a first radio access technology network, and program code to initiate a determination regarding communication coverage by a radio access technology network site of a second radio access technology network. An area of the communication coverage corresponds at least in part to an area of communication coverage of the radio access technology network site of the first radio access technology network. The program code further includes program code to initiate communication via the radio access technology network site of the first radio access technology network to request enabling the radio access technology site of the second radio access technology network, and program code to initiate establishing a communication link with the radio access technology network site of the second radio access technology network to obtain the service feature and provide continued communication services within a portion of a service area impacted by energy saving technique operation of the radio access technology network site of the second radio access technology network.

In an additional aspect of the disclosure, a computer program product for wireless communications in a wireless network, includes a computer-readable medium having program code recorded thereon. The program code includes program code to receive, via a radio access technology site of a first radio access technology network, a request to enable a radio access technology site of a second radio access technology network for providing a service feature not available from the radio access technology site of the first radio access technology network, program code to select a radio access technology site of the second radio access technology network for providing the service feature, and program code to coordinate operation of the first radio access technology network and the second radio access technology network to provide continued wireless communication services for the service feature within at least a portion of a communication coverage area of the radio access technology site of the second radio access technology network.

The foregoing has outlined rather broadly the features and technical advantages of aspects of the present disclosure in order that the detailed description of the concepts that follow may be better understood. Additional features and advantages of aspects of the disclosure will be described hereinafter which form the subject of the claims. It should be appreciated by those skilled in the art that the conception and specific embodiment disclosed may be readily utilized as a basis for modifying or designing other structures for carrying out the same purposes of the aspects of the present disclosure. It should also be realized by those skilled in the art that such equivalent constructions do not depart from the spirit and scope of the concepts as set forth in the appended claims. The novel features which are believed to be characteristic of aspects of the disclosure, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWING

For a more complete understanding of the present disclosure, reference is now made to the following descriptions taken in conjunction with the accompanying drawing, in which:

FIG. 1 shows a wireless communication system, comprising an underlay network and an overlay network, as may be provided continued subscriber services with inter-RAT network energy savings according to the concepts herein;

FIG. 2 shows a flow diagram of a method wherein performance factors are utilized for controlling energy saving operation in accordance with an aspect of the disclosure;

FIGS. 3-6 show configurations implementing energy saving techniques facilitating service continuity in accordance with the concepts herein;

FIG. 7 shows a method operable at an access terminal for providing service continuity according to aspects of the present disclosure;

FIG. 8 shows a method operable at network energy savings intelligence for providing service continuity according to aspects of the present disclosure;

FIGS. 9-12 show call flows implementing service continuity in accordance with the concepts herein; and

FIGS. 13 and 14 show processor-based system configurations as may implement functionality providing continued subscriber services in accordance with the concepts herein.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Aspects of the present disclosure are directed to systems and methods which facilitate wireless communication network energy savings through the use of inter-RAT energy savings schemes adapted to minimize or mitigate the effect of gaps in service area coverage and thus enable continued wireless communication services. Using aspects disclosed herein, wireless communication network operators are enabled to implement intelligence for network energy savings thereby reducing their OPEX. Network energy savings intelligence in accordance with aspects herein operates to extend intra-RAT energy saving frameworks to inter-RAT energy savings frameworks with no or minimal user experience degradation, such as by facilitating selection of network resources (e.g., base stations, carriers, transmitters, receivers, antenna systems, power amplifiers, etc.) for implementation of energy savings techniques, adjustment of network resources for optimizing service area coverage during implementation of energy savings techniques, making determinations regarding when aspects of an energy savings technique are to be invoked or exited. Such network energy savings intelligence may be provided as logic within particular network infrastructure (e.g., base station controllers (BSCs), radio network controllers (RNCs), etc.) and/or as separate energy savings infrastructure (e.g., one or more network energy savings controller (NESCs)).

Network energy savings intelligence may additionally be utilized according to aspects of the disclosure which facilitate service continuity with respect to particular services during implementation of energy savings techniques. For example, a technique for capturing requests for particular services, which might otherwise be unavailable due to implementation of an energy savings technique applied to a given RAT, may be provided whereby a user's experience with respect to the service is maintained while inter-RAT operation is performed in order to provide a requested service. Little or no changes to the air interface or wireless communication standards need be made when providing service continuity techniques according to aspects of the present disclosure, thereby readily allowing wireless communication network operators to realize inter-RAT energy savings with no or minimal user experience degradation.

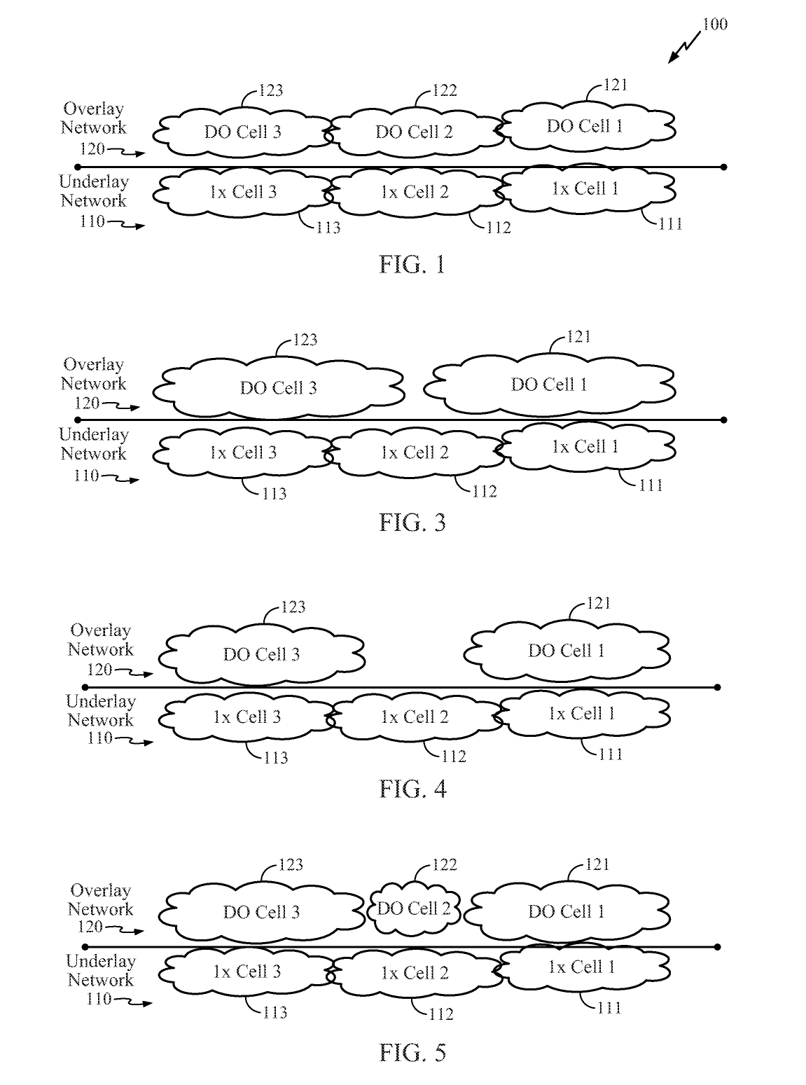

In order to better understand the concepts disclosed herein, reference will be made to an exemplary wireless communication system comprising a wireless communication network implementing a first RAT (also referred to herein as an underlay network or underlay RAT) and a wireless communication network implementing a second RAT (also referred to herein as an overlay network or overlay RAT). FIG. 1 illustrates wireless communication system 100 comprising underlay network 110 and overlay network 120. Underlay network 110 of the illustration comprises a plurality of sites, shown as cells 111-113, such as may comprise cellular base stations (BSs) providing wireless communications within an associated portion (e.g., “cell”) of a service area. Similarly, overlay network 120 of the illustration comprises a plurality of sites, shown as cells 121-123, such as may comprise cellular BSs providing wireless communications within an associated portion (e.g., “cell”) of a service area.

Cells 111-113 of underlay network 110 operate in accordance with a first RAT, such as CDMA 1x, while cells 121-123 of overlay network 120 operate in accordance with a second RAT, such as CDMA 1x EV-DO. Accordingly, different services, features, etc. may be available/provided when terminal equipment, such as access terminals (ATs), user equipment (UEs), mobile stations (MSs), handheld devices, subscriber equipment, etc. (collectively referred to herein as ATs), receive wireless communication services from infrastructure of underlay network 110 or overlay network 120. It should be appreciated that the particular RATs of the illustration are exemplary and thus the concepts herein may be applied to various other RATs, including GSM, CDMA, UMTS, 3GPP2, 3G, 4G, LTE, etc.

For example, the techniques described herein may be used for various wireless communication networks such as CDMA, TDMA, FDMA, OFDMA, SC-FDMA and other networks. The terms “network” and “system” are often used interchangeably. A CDMA network may implement a radio technology, such as Universal Terrestrial Radio Access (UTRA), Telecommunications Industry Association's (TIA's) CDMA2000®, and the like. The UTRA technology includes Wideband CDMA (WCDMA) and other variants of CDMA. The CDMA2000® technology includes the IS-2000, IS-95 and IS-856 standards from the Electronics Industry Alliance (EIA) and TIA. A TDMA network may implement a radio technology, such as Global System for Mobile Communications (GSM). An OFDMA network may implement a radio technology, such as Evolved UTRA (E-UTRA), Ultra Mobile Broadband (UMB), IEEE 802.11 (Wi-Fi), IEEE 802.16 (WiMAX), IEEE 802.20, Flash-OFDMA, and the like. The UTRA and E-UTRA technologies are part of Universal Mobile Telecommunication System (UMTS). 3GPP Long Term Evolution (LTE) and LTE-Advanced (LTE-A) are newer releases of the UMTS that use E-UTRA. UTRA, E-UTRA, UMTS, LTE, LTE-A and GSM are described in documents from an organization called the “3rd Generation Partnership Project” (3GPP). CDMA2000® and UMB are described in documents from an organization called the “3rd Generation Partnership Project 2” (3GPP2). The techniques described herein may be used for the wireless networks and radio access technologies mentioned above, as well as other wireless networks and radio access technologies.

For example, in an exemplary system in which the concepts of the present disclosure may be applied, the underlay RAT could be UMTS and the overlay RAT could be LTE. Alternatively, the underlay RAT could be GSM and the overlay RAT could be UMTS. Similarly, the underlay RAT could be CDMA 1x EV-DO and the overlay RAT could be LTE. In general, any combination of 2G, 3G, and 4G networks can be used as underlay and overlay networks in the application of the concepts herein, wherein the older technology is typically acting as the underlay network as the coverage is assumed to be ubiquitous compared to the newer technology that acts as overlay network.

For simplifying the concepts described herein, assume a ubiquitous CDMA 1x coverage with respect to underlay network 110 and CDMA 1x EV-DO coverage with respect to overlay network 120 in a region of interest (e.g., the service area) in the configuration illustrated in FIG. 1. Likewise, assume that the CDMA 1x and CDMA 1x EV-DO cells overlap completely (e.g., the cells of the underlay network and the overlay network are co-located, providing wireless communications within overlapping areas). There is, however, no limitation to the use of such an arrangement of underlay network and overlay network cells. Concepts disclosed herein are applicable to various different configurations of underlay and overlay networks, including those having cells which are not co-located.

Various techniques for realizing energy savings may be invoked with respect to infrastructure of underlay network 110 and/or overlay network 120. For example, intra-RAT energy savings techniques may be invoked with respect to BSs of cells 121-123 of overlay network 120, such as during off-peak periods, periods of low utilization of one or more network resource, etc. Through appropriate application of network energy savings intelligence such intra-RAT energy saving frameworks may be coordinated with operation of resources of another RAT to provide inter-RAT energy savings frameworks with no or minimal user experience degradation. Inter-RAT energy savings frameworks provided in accordance with aspects herein may be invoked using intelligent selection of network resources for implementation of energy savings techniques, adjustment of network resources for optimizing service area coverage during implementation of energy savings techniques, making determinations regarding when aspects of an energy savings technique are to be invoked or exited.

For example, in order to minimize degradation in the user experience during intra-RAT energy saving operations, the resources (e.g., cell or cells) which are to operate in the energy saving mode may be carefully selected, such as to minimize user experience impact with respect to use of the RAT and/or to facilitate inter-RAT operation for minimizing user experience through cooperative operation of the RATs. User experience degradation may be minimized by controlling energy saving operation with respect to resources having low utilization, for which service, or some portion thereof, may be shifted to other resources of the RAT or resources of another RAT, etc. Accordingly, various performance factors may be utilized for controlling energy saving operation according to the concepts herein.

Performance factors which may be utilized for controlling energy saving operation in accordance with an aspect of the disclosure may include analysis of a candidate resource to determine a type of the resource. For example, a cell may be of a coverage site type or of a capacity site type. Typically, initial deployment of a network aims at providing sufficient signal coverage to the planned service area. For this reason, the site location, antenna height, etc. of the initially deployed cells are often chosen to provide the best network coverage. These cells can be classified as being of a “coverage” site type. As the traffic demand grows and when limited by spectrum availability, the wireless communication network operator often adds additional sites with focus on high traffic demand area. These cells primarily aim at providing additional capacity in a high traffic demand area. These cells can be classified as being of a “capacity” site type. Cells determined to be of a capacity site type may be selected for operation of an energy savings technique (e.g., the resource being powered down or operated in a low power mode, such as to decrease transmit power, to power down one or more carrier of a multiple carrier cell, etc.) during periods of expected or actual low use. For example, network energy savings intelligence operating according to aspects herein may access a database providing information regarding resource type when determining if a particular cell or other resource is a suitable candidate for implementing one or more feature of an energy savings technique.

Additionally or alternatively, traffic volume is a performance factor which may be utilized for controlling energy savings operation in accordance with aspects of the disclosure. Particular resources, such as a given cell, may be identified as a candidate for implementing an energy savings technique when the local traffic demand at the cell is expected to be low and/or when another resource, whether of the same or a different RAT, is determined to be capable of sufficiently serving the expected local traffic (e.g., disposed to provide coverage to the appropriate portion of the service area and has available capacity to serve the expected traffic). For example, network energy savings intelligence operating according to aspects herein may access historical traffic pattern information (e.g., past daily traffic pattern information stored in a database) and/or current traffic volume metrics (e.g., as reported by one or more wireless communication network resource) regarding resources of one or more RAT to perform analysis with respect to the amount traffic during the energy saving mode operation. Network energy savings intelligence operating according to aspect herein may determine predicted traffic volume metrics (e.g., predicted based upon historical usage patterns, based upon current usage trends, based upon scheduled events, etc.). Such traffic volume information may be utilized in determining if a particular cell or other resource is a suitable candidate for implementing one or more feature of an energy savings technique (e.g., whether the traffic volume on a cell of the overlay network is or is expected to be sufficiently low to suggest energy savings operation and/or whether the traffic volume on a cell of the underlay network is or is expected to be suitable for providing continued wireless communications in an affected area through the cell of the underlay network).

Remaining wireless communication network resources performance is another performance factor which may be utilized for controlling energy savings operation in accordance with aspects of the disclosure. For example, network energy savings intelligence may operate to determine whether a coverage gap will result from implementation of an energy savings technique with respect to a particular resource, the extent of the gap, the number, type, etc. of ATs likely to be affected by the gap, and the like in determining whether an energy savings technique is to be invoked with respect to the resource. Network energy savings intelligence operating according to aspects herein may analyze other resources of the RAT (e.g., intra-RAT resource performance analysis in both coverage and capacity) with respect to an expected network coverage gap area, such as by analyzing performance metrics provided by one or more network resource, to determine if an energy savings technique is to be invoked with respect to a candidate resource.

From the foregoing it can be appreciated that wireless communication network resources performance factor analysis may be applied with respect to inter-RAT operation. Where an overlay network resource, for example, is a candidate for implementing an energy savings technique, underlay network performance metrics and available services may be analyzed by network energy savings intelligence operating according to aspects herein to determine if the overlay network resource is a suitable candidate for implementing the energy savings technique. Where coverage gaps are created in the overlay network as a result of implementing an energy savings technique, the ATs in the overlay network coverage gap may be served by the underlay network, thus obtaining at least some wireless communication services from the resources of the underlay network. Therefore, network energy savings intelligence operating according to aspects herein analyze underlay network performance (e.g., intra-RAT resource performance analysis in both coverage and capacity) with respect to the expected overlay network coverage gap area, such as by analyzing performance metrics provided by one or more underlay network resource, to determine if an energy savings technique is to be invoked with respect to a candidate resource.

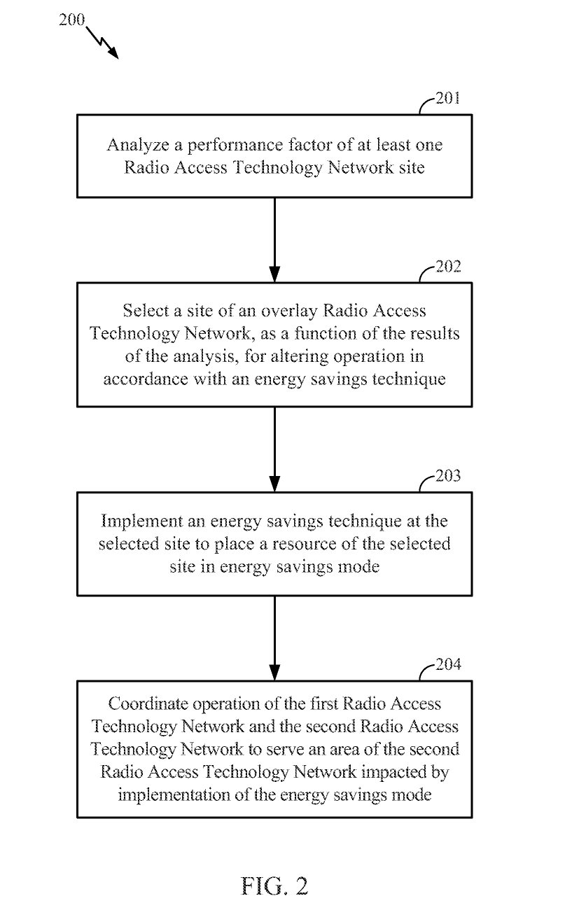

FIG. 2 shows a flow diagram of a method wherein performance factors are utilized for controlling energy saving operation in accordance with an aspect of the disclosure. Method 200 shown in FIG. 2 includes block 201 analyzing a performance factor of at least one radio access technology network site. The at least one radio access technology network site may be selected from the group consisting of one or more radio access technology network sites of a first radio access technology network and one or more radio access technology network sites of a second radio access technology network. At block 202 of method 200 shown in FIG. 2, a site of a second radio access technology network is selected, as a function of the results of the analysis, for altering operation in accordance with an energy saving technique (e.g., powering down of a resource of the site). An energy saving technique is invoked at the selected site of the second radio access technology network to place a resource of the selected site in energy savings mode at block 203. At block 204, operation of the first radio access technology network and the second radio access technology network are coordinated to serve an area of the second radio access technology network impacted by implementation of the energy savings mode.

Aspects of the disclosure may operate to select particular wireless communication network resources for implementing energy saving schemes using criteria such as selecting those capacity site type cells where traffic demand of the cells is expected low, where any resulting coverage gaps can be effectively handled by intra-RAT and/or inter-RAT network resources, etc. The configurations of wireless communication system 100 of FIGS. 3-5 illustrate the operational results of application of the foregoing concepts.

As a baseline, assume that each of cells 121-123 of overlay network 120 are transmitting at a given, nominal power level in the configuration illustrated in FIG. 1. In the configuration illustrated in FIG. 3, implementing an energy saving technique in accordance with the concepts herein, cell 122 is powered off and the power for cells 121 and 123 is increased (e.g., transmit power amplifier (PA) power is increased) to help with user experience while still achieving energy savings. In this case, cells 121 and 123 grow because of the increased power and the reduction in intra-frequency interference. It should be appreciated that, in the configuration of FIG. 3, expanded cells 121 and 123 will almost overlap but not completely and thereby a gap in coverage with respect to overlay network 120 results. The operational configuration of FIG. 3 may be based on a determination by the network energy savings intelligence that the load on cell 122 is, or is expected to be, low and that an expansion of cells 121 and 123 results in a coverage gap unlikely to significantly impact user experience, that cell 112 of underlay network 110 can provide suitable services with respect to ATs disposed in, or likely to be disposed in, the resulting gap, etc. Accordingly, network energy savings intelligence may operate to determine that user experience degradation is unlikely because ATs are unlikely to be disposed in the relatively small coverage gap and/or the coverage gap can be served by the underlay network resources. Energy savings is realized in such a configuration because the increase in power for the two cells (cells 121 and 123) is less than the savings from powering off of the one cell (cell 122).

In the configuration illustrated in FIG. 4, implementing another energy saving technique in accordance with the concepts herein, cell 122 is powered off while the power for cells 121 and 123 remains unchanged from that of the baseline operation of the configuration of FIG. 1. In this configuration, the coverage of cells 121 and 123 is still enlarged (e.g., due to the reduction in intra-frequency interference), however a coverage gap with respect to overlay network 120 is present. Moreover, because the power of cells 121 and 123 is not increased, the resulting gap in coverage is expected to be larger than that of the configuration of FIG. 3. The operational configuration of FIG. 4 may be based on a determination by the network energy savings intelligence that the load on cell 122 is, or is expected to be, very low and that the resulting coverage gap is unlikely to significantly impact user experience, that cell 112 of underlay network 110 has, or will have, sufficient resources to provide suitable services with respect to ATs disposed in, or likely to be disposed in, the resulting gap, etc. Accordingly, network energy savings intelligence may operate to determine that user experience degradation is unlikely because ATs are unlikely to disposed in the coverage gap and/or the coverage gap can be adequately served by the underlay network resources. Energy savings is realized in such a configuration from powering off of the one cell (cell 122).

In energy savings operation according to aspects of the disclosure, cell 122 is not shut off for all times for the operational configurations of FIGS. 3 and 4. For example, cell 122 may be shut off based on observations that load on cell 122 is low etc. Cell 122 may thereafter be turned on if there is a need (e.g., ATs disposed in the coverage gap are detected, exceed a threshold, reach a point underlay network resources are unable to provide adequate services, quality of service (QoS) needs, quality of experience (QoE) metrics, etc.).

In the configuration illustrated in FIG. 5, implementing yet another energy saving technique in according with the concepts herein, the power of cell 122 is decreased while the power for cells 121 and 123 remains unchanged from that of the baseline operation of the configuration of FIG. 1. Essentially, the operational configuration of FIG. 5 is an enhancement of the operational configuration of FIG. 4 in that instead of putting cell 122 in power down mode, cell 122 is operated to transmit at reduced power. The operational configuration of FIG. 5 may be based on a determination by the network energy savings intelligence that the load on cell 122 is, or is expected to be, sufficient to suggest that cell 122 should not be powered off, although the capacity is insufficient to demand full nominal power operation, that cell 112 of underlay network 110 has, or will have, sufficient resources to provide suitable services with respect to ATs disposed in, or likely to be disposed in, the resulting gaps, etc. Accordingly, network energy savings intelligence may operate to determine that user experience degradation is unlikely because ATs are unlikely to disposed in the relatively small coverage gaps and/or the coverage gaps can be adequately served by the underlay network resources. Energy savings is realized as full nominal operating power is not utilized for cell 122. Energy savings is realized in such a configuration from the decrease in power of the one cell (cell 122).

In the case of the operational configuration of FIG. 4 it is expected that there will be more energy savings realized as compared to the operational configuration of FIG. 3 (i.e., the energy savings of powering off cell 122 is not offset by a corresponding increase in the power of cells 121 and 123). However, the inter-RAT cooperation providing resources in the overlay network coverage gap are more heavily relied upon in the energy savings technique determination and in providing energy savings without significantly impacting the user experience. In the case of the operational configuration of FIG. 5 the energy savings are expected to be smaller than those resulting from the configuration of FIG. 4, and perhaps even smaller than those of the configuration of FIG. 3. However, the resulting coverage gap(s) are expected to be the smallest of the foregoing configurations, thereby relying the least upon inter-RAT cooperation providing resources in the overlay network coverage gap. Accordingly, it can be appreciated that the energy saving techniques of the configurations illustrated in FIGS. 3, 4, and 5 present tradeoffs which may be analyzed and balanced by network energy savings intelligence when determining energy savings techniques to be invoked with respect to one or more resources of wireless communication system 100.

It should be appreciated that, although the energy savings operational configurations of FIGS. 3-5 are illustrated with reference to CDMA 1x and CDMA 1x EV-DO networks, the concepts can be applied between any two RATs with one acting as anchor RAT (e.g. underlay RAT) and the other acting as overlay RAT. The energy savings techniques may, for example, be applied with respect to GSM/UMTS, UMTS/LTE, CDMA 1x EV-DO/LTE or any such combinations. The energy savings will be realized for the overlay RAT by this scheme though energy savings can independently be achieved for the underlay RAT. It is to be noted that the energy savings scheme for overlay intra RAT energy savings will be less aggressive than permitted by inter-RAT energy savings scheme as the former does not rely on the underlay RAT for coverage. Similarly, the energy savings scheme for underlay intra-RAT energy savings could be more aggressive than permitted by inter-RAT energy savings scheme as the latter ensures satisfactory coverage for both underlay and overlay networks. For example, network energy savings intelligence of aspects of the disclosure may operate to implement energy savings with respect to resources of the underlay network (e.g., power off one or more carrier of a multiple carrier underlay cell where user load permits) in combination with the foregoing energy savings operational configurations invoked with respect to an overlay network. A systematic approach of turning off overlay network resources, starting with few carriers until all the carriers in selected cells are turned off, transitions seamlessly from intra-RAT energy savings to inter-RAT energy savings as resources of the underlay network are then subjected to energy savings operation. It should be appreciated that energy savings operation with respect to resources of the underlay network may be applied less aggressively (e.g., turning off of less than all resources in a underlay cell, using decreased power rather than turning off resources, etc.) in order to maintain at least a minimal level of service throughout a service area and thus maintain the user experience. For aggressive energy savings to be realized for the underlay RAT, the underlay and overlay RATs may be exchanged.

Powering off and/or powering down various network resources, as may be implemented in energy savings operational configurations of FIGS. 3-5, may not be performed instantaneously. For example, network resources (e.g., cells, carriers, etc.) may be powered off or powered down in one or more steps or otherwise performed over time. Similarly, bringing the network resources out of energy savings operation may be performed in one or more steps. Additionally or alternatively, where multiple network resources are taken into or out of energy savings operation, the powering off or on of such resources may be staggered (e.g., one after the other, delay between initiating energy savings operation of network resources, etc.).

Energy savings operational configurations, such as those illustrated in FIGS. 3-5, may implement a combination of techniques to facilitate energy savings while continuing to provide wireless communication services without substantial impact upon the user experience. Aspects of the disclosure provide for one or more adjustments for optimizing RAT coverage, whether overlay or underlay RAT coverage, for implementing energy savings techniques. As described in detail below, antenna systems, transmission power, data rates, frequency reuse patterns, etc. may be adjusted or otherwise controlled to improve coverage and reduce coverage gaps when implementing energy savings techniques. Accordingly, the resulting coverage provided by such techniques may be considered as performance factors utilized for controlling energy saving operation according to the concepts herein.

To optimize overlay RAT coverage during inter-RAT energy saving operation, aspects of the disclosure may implement adjustments to a cell's BS antenna configuration. Next generation networks are often equipped with Remote Electrical Tilt (RET) control architecture. For RET, the antenna tilt and azimuth steering may be controlled via a control unit located within the BSC. Network energy savings intelligence may control such RET antennas to adjust the coverage of cells/sectors in association with implementing energy savings techniques, such as powering off or reducing power of a cell. For example, the increased coverage of cells 121 and 123 may be provided by RET antenna adjustment, perhaps in combination with a lesser increase in power of the cells, in the operational configuration of FIG. 3. The coverage provided may be based on the predictions and configurations and real time traffic demand. The underlay and overlay RAT may communicate their coverage, antenna tilt, and azimuth settings to the network energy savings intelligence to facilitate going to a new setting and then reverting back to an old setting based on underlay/overlay network coverage and energy savings implementation.

Additionally or alternatively, to optimize overlay RAT coverage during inter-RAT energy saving operation, aspects of the disclosure may implement adjustment of PA power (e.g., 16-20 watt for single carrier and MCPA˜36 watts catering 3 carriers). It should be noted that the PA power can be significantly reduced with minimal coverage impact. In wireless networks, the propagation exponent typically ranges from 3 to 5. Assuming propagation exponent of 4, 12 dB PA power reduction only reduces the cell radius by ½ (i.e., the coverage region is reduced by ¼). The overall impact to the coverage by 10-12 dB transmit power reduction with respect to such a capacity site type cells may often be negligible. Furthermore, if the sites have the RET capability, the coverage impact can be further reduced by slightly up-tilting the antennas of the sites during the low power operation. Though the PA power reduction does not reduce the power consumption of the site proportionally (i.e. linearly), there remains potential for energy savings to be achieved by application of this technique.

Moreover, to optimize overlay RAT coverage during inter-RAT energy saving operation, aspects of the disclosure may implement adjustment of one or more Control Channel (CC) or other overhead channel data rate. For example, network energy savings intelligence may determine that the CC data rate may be reduced from 76.8 kbps to 38.4 kbps. Reducing the CC data rate of the cells of overlay network 120 may effectively extend the coverage area of those cells. Thus, the CC data rate of cells 121 and 123 may be reduced in the energy savings operational configuration of FIG. 3 to facilitate the relatively small coverage gap therein. It should be appreciated that CC data rate adjustments may be implemented in combination with other adjustments (e.g., the above listed adjustments) to provide energy savings while maintaining the user experience.

To optimize overlay RAT coverage during inter-RAT energy saving operation, aspects of the disclosure may additionally or alternatively implement adjustments to the use of carriers (e.g., frequency use/reuse) within the wireless communication network. Implementation of adjustments to the use of carriers in one set of network infrastructure (e.g., the overlay network) as described herein may be made with or without carrier use adjustments in another set of network infrastructure (e.g., the underlay network). For example, similar carrier use adjustment techniques may be applied in parallel for overlay network 120 and underlay network 110. Network energy savings intelligence may implement control of the carrier use adjustments such that the cells in the underlay network in which carriers are turned off do not coincide, or substantially coincide, with cells in the overlay network in which carriers are turned off.

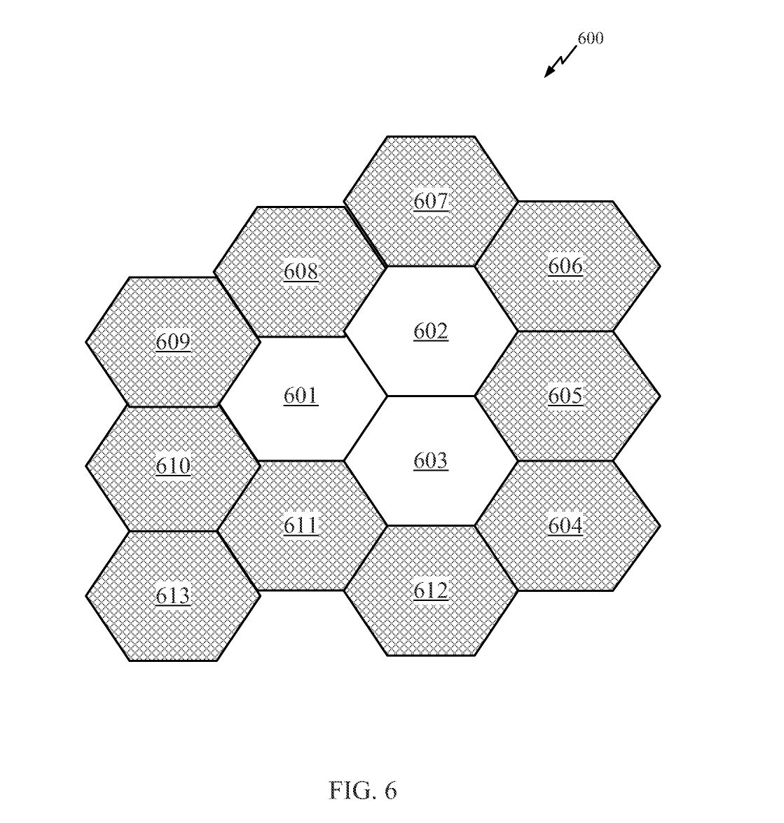

To aid in understanding energy savings operation according to this aspect of the disclosure, attention is directed to FIG. 6 wherein the cells of overlay network 600 are shown in plain view. It should be appreciated that the cells of overlay network 600 of the illustrated embodiment may correspond to cells of overlay network 120 illustrated in elevation view in FIGS. 1 and 3-5. For example, cell 601 may correspond to cell 121, cell 603 may correspond to cell 122, and cell 602 may correspond to cell 123, while cells 604-613 are not shown in FIGS. 1 and 3-5.

As shown in FIG. 6, cells 601-613 of overlay network 600 are disposed in a cellular pattern and provide wireless communication service within a portion of a service area. Assume that, in non energy saving mode, there are 3 carriers (F1-F3) available for use at each of cells 601-613. Operation of an energy savings technique according to aspects herein may power off select ones of these resources (e.g., power of particular carriers at one or more cells) under control of network energy savings intelligence.

For example, in operation according to concepts of the present disclosure, when load conditions are detected to have dropped below a first load threshold in an inner cluster of cells (e.g., cells 601, 602, and 603 of overlay network 600) one carrier of each of these cells may be turned off or put in standby mode to provide an initial level of energy savings. Although load conditions are mentioned in the example above, it should be appreciated that additional or alternative metrics (e.g., time of day) may be compared to one or more threshold for invoking energy savings. The following carriers are turned off or put in standby mode according to an aspect of the disclosure: Carrier on F1 is turned off in cell 601; Carrier on F2 is turned off in cell 602; and Carrier on F3 is turned off in cell 603. The coverage provided by one or more carriers in the neighboring cells may be extended (e.g., as described above with respect of the configuration of FIG. 3) so as to minimize any coverage gap region. Additionally or alternatively, antenna tilting and azimuth steering as discussed above may be utilized to provide extended coverage in a given direction.

The table below (Table 1) illustrates the use of carrier frequencies in the foregoing energy savings technique, wherein “X” indicates the carriers that are on.

TABLE 1

| | Overlay | | |
|---|---|---|---|
| | RAT carriers | | |
| | frequency | | |
| Cells | F1 | F2 | F3 |
| 601 | | X | X |
| 602 | X | | X |
| 603 | X | X | |
| 604 | X | X | X |
| 605 | X | X | X |
| 606 | X | X | X |
| 607 | X | X | X |
| 608 | X | X | X |
| 609 | X | X | X |
| 610 | X | X | X |
| 611 | X | X | X |
| 612 | X | X | X |
| 613 | X | X | X |

As can be seen in Table 1 above, in operation of the foregoing exemplary energy savings technique, when the carrier on F1 is turned off in cell 601, there is still coverage provided by the carriers on F2 and F3. In addition, neighboring cells 602, 603, 611, 610, 609, and 608 provide coverage using carriers on F1 by extended coverage resulting from adjustments and/or reductions in the intra-frequency interference. Similarly, when the carrier on F2 is turned off in cell 602, there is still coverage provided by the carriers on F1 and F3. In addition, neighboring cells 601, 608, 607, 606, 605, and 603 provide coverage by carriers on F2 by extended coverage. When the carrier on F3 is turned off in cell 603, there is still coverage provided by the carriers on F1 and F2. In addition, neighboring cells 601, 602, 605, 604, 612, and 611 provide coverage by carriers on F3 by extended coverage. Moreover, coverage may be provided within the coverage area of cells 601, 602 and 603 by cells of the underlay network.

In operation according to concepts of the present disclosure, one or more additional carrier may be turned off based on various, configurable thresholds. For example, when load conditions are detected in the above mentioned inner cluster of cells (e.g., cells 601, 602, and 603 of overlay network 600) to have dropped below a second load threshold a plurality of carriers per cell may be turned off or put in standby mode. Although load conditions are mentioned in the example above, it should be appreciated that additional or alternative metrics (e.g., time of day) may be compared to one or more threshold for invoking energy savings. The following carriers are turned off or put in standby mode according to an aspect of the disclosure: Carriers on F1 and F2 are turned off in cell 601; Carriers on F2 and F3 are turned off in cell 602; and Carriers on F1 and F3 are turned off in cell 603. As above, the coverage provided by one or more carriers in the neighboring cells may be extended (e.g., as described above with respect of the configuration of FIG. 3) so as to minimize any coverage gap region. Additionally or alternatively, antenna tilting and azimuth steering may be utilized to provide extended coverage in a given direction.

The table below (Table 2) illustrates the use of carrier frequencies in the foregoing energy savings technique, wherein “X” indicates the carriers that are on.

TABLE 2

| | Overlay | | |
|---|---|---|---|
| | RAT carriers | | |
| | frequency | | |
| Cells | F1 | F2 | F3 |
| 601 | | | X |
| 602 | X | | |
| 603 | | X | |
| 604 | X | X | X |
| 605 | X | X | X |
| 606 | X | X | X |
| 607 | X | X | X |
| 608 | X | X | X |
| 609 | X | X | X |
| 610 | X | X | X |
| 611 | X | X | X |
| 612 | X | X | X |
| 613 | X | X | X |

As can be seen in Table 2 above, in operation of the foregoing exemplary energy savings technique, when carriers on F1 and F2 are turned off in cell 601, there is still coverage provided by the carrier on F3. In addition, neighboring cells 602, 611, 610, 609, and 608 provide coverage by the carrier on F1 and neighboring cells 603, 611, 610, 609, and 608 provide coverage by the carrier on F2 by extended coverage. Similarly, when carriers on F2 and F3 are turned off in cell 602, there is still coverage provided by the carrier on F1. In addition, neighboring cells 608, 607, 606, 605, and 603 provide coverage by the carrier on F2 and neighboring cells 601, 608, 607, 606, and 605 provide coverage by the carrier on F3 by extended coverage. When carriers on F1 and F3 are turned off in cell 603, there is still coverage provided by the carrier on F2. In addition, neighboring cells 602, 605, 604, 612, and 611 provide coverage by the carrier on F1 and neighboring cells 605, 604, 612, 611, and 601 provide coverage by the carrier on F3 by extended coverage. Moreover, coverage may be provided within the coverage area of cells 601, 602 and 603 by cells of the underlay network.

In operation according to concepts of the present disclosure, all carriers within a cell may be turned off or put in standby mode based on various, configurable thresholds. For example, when load conditions are detected in the above mentioned inner cluster of cells (e.g., cells 601, 602, and 603 of overlay network 600) to have dropped below a third load threshold all carriers of those cells may be turned off or put in standby mode. Although load conditions are mentioned in the example above, it should be appreciated that additional or alternative metrics (e.g., time of day) may be compared to one or more threshold for invoking energy savings. This energy savings operation results in the cell having been turned off as described above with respect to the energy savings operation of cell 122 in the configurations of FIGS. 3 and 4. Accordingly, coverage in those cells (cells 601, 602, and 603) may be provided by the carriers of the neighboring overlay network cells and/or cells of the underlay network.

The table below (Table 3) illustrates the use of carrier frequencies in the foregoing energy savings technique, wherein “X” indicates the carriers that are on.

TABLE 3

| | Overlay | | |
|---|---|---|---|
| | RAT carriers | | |
| | frequency | | |
| Cells | F1 | F2 | F3 |
| 601 | | | |
| 602 | | | |
| 603 | | | |
| 604 | X | X | X |
| 605 | X | X | X |
| 606 | X | X | X |
| 607 | X | X | X |
| 608 | X | X | X |
| 609 | X | X | X |
| 610 | X | X | X |
| 611 | X | X | X |
| 612 | X | X | X |
| 613 | X | X | X |

It should be appreciated that network energy savings intelligence operating in accordance with concepts herein may operate to turn on any carrier of any cell in the foregoing energy savings techniques as determined to be desirable. For example, one or more carrier may be turned on or otherwise brought out of standby mode based on various performance factors such as QoS needs, QoE metrics, load, etc.

A performance factor which may be utilized in determining when one or more resource is to be brought out of energy savings operation by network energy savings intelligence is Access Round Trip Delay (ARTT) implemented by some network protocols. CDMA networks (e.g., CDMA 1x networks) use ARTT to determine the distance of the AT from the cell site (e.g., the chip delay is essentially used to determine distance). In an energy saving technique, as discussed above, where an overlay network resource (e.g., cell or carrier) is turned off while extending the coverage of neighboring cells to compensate for the coverage, users who would have been served by the shut off resource will now have higher ARTT. This information can be used by network energy savings intelligence to determine that there are users in the region that can be better served by turning on the overlay network resource and thereby used to trigger the resource turn on. Accordingly, aspects of the present disclosure use performance factors such as ARTT to determine if some resources which are in energy savings mode are to be brought out of energy savings operation.

Other performance factors which may be utilized in determining when one or more resources is to be brought out of energy savings operation by network energy savings intelligence include load metrics. For example, the load experienced by an underlay network cell providing service to an area in which an overlay network cell has been powered off may be used in determining that one or more network resource (e.g., one or more carrier of the overlay network cell) is to be brought out of energy savings operation. Similarly, the load experienced by a carrier which remains operational during times of other carriers of that cell being in energy savings operation may be used in determining that one or more network resource (e.g., one or more of the carriers in energy savings mode) is to be brought out of energy savings operation.

It should be appreciated that determinations regarding bringing resources out of energy savings operation may be based upon indications other than performance factors of the RAN of the resource. For example, bringing resources out of energy savings operation on the overlay network can be based on various indications, such as time of day, type of services being accessed by users, types or categories of users/UEs accessing the network, etc. In operation according to embodiments herein, energy savings operation may be rolled back when degradation in user experience (e.g., QoS, QoE, etc.) is detected or observed. Such indications may be from within the network in which the energy savings operation being altered is located or external thereto (e.g., one or more indications regarding altering the operation of resources of the overlay network may be provided from the underlay network). Such indications, whether from the same or another network, may be alone or in combination with other factors (e.g., indications from other active resources of the overlay network itself, such as the aforementioned ARTT information, load information, etc., in combination with indications from the underlay network).

Various techniques may be implemented with respect to bringing resources out of energy savings operation according to aspects of the present disclosure. Resources may be brought back into operation under control of network energy savings intelligence to minimize negative impact upon network performance, user experience, energy consumption, etc. For example, where a particular cell is powered off, operation to bring that cell out of energy savings operation may control the cell to bring different carriers thereof online over time, thereby avoiding an unacceptable spike in energy consumption, abrupt handover of a large number of user's between various network resources, etc. Additionally or alternatively, techniques adapted to maintain user experience may bring particular resources out of energy savings operation which facilitate service continuity during implementation of energy savings techniques.

A technique for bringing one or more resource out of energy savings operation which facilitates service continuity for a service according to an aspect of the disclosure enables operators to provide service continuity for particular services, such as for premium services, and at the same realize the full benefits of inter-RAT energy savings. Implementation of a service continuity technique in accordance with the concepts of the present disclosure operates to capture requests for particular services, which might otherwise be unavailable due to network resources being operated in an energy savings mode, and alter the energy savings operation of resources to facilitate the requested services. Using such a technique, inter-RAT operation is performed in order to provide a requested service and maintain a user's experience with respect to the service.

For example, some applications (e.g., push-to-talk communications, such as QCHAT available from Qualcomm Inc., packet switched video telephony (PSVT), etc.) may be available only through resources of a particular RAT (e.g., available on an overlay RAT, such as HRPD or UMTS, and not available on an underlay RAT, such as CDMA 1x or GSM). These applications and the services provided thereby are referred to herein as RAT specific services, although it should be appreciated that such RAT specific services may be operable with respect to a plurality of RATs but nevertheless are not operable with respect to some other RATs. If an operator wants to provide these RAT specific services with an acceptable user experience (e.g., the services are reliably and consistently available), the operator would not be able to realize the full benefits of energy savings because implementing energy savings with respect to the network resources may render the RAT specific services unavailable to users. If operators were nevertheless to proceed with energy savings operation, there would be users who would not have access to some premium services (RAT specific services) they paid for, at least during some hours.

In order to better understand concepts of a service continuity technique operable according to aspects of the present disclosure, assume that a particular RAT specific service is available only through use of resources of overlay network 120. Accordingly, operation to provide the RAT specific service is not natively supported through use of resources of underlay network 110. If a user is disposed in a coverage gap area resulting from energy savings operation applied to the resources of overlay network 120 (e.g., coverage gaps associated with the energy savings operation discussed above with respect to any of the configurations of FIGS. 3-5 above), the RAT specific services associated with overlay network 120 may not be available. A service continuity technique herein provides an overlay RAT enable request when a request for such an otherwise unavailable RAT specific service is made.

In accordance with a service continuity technique herein, operators may push an application update/patch (e.g., instruction set, also referred to herein as RAT enable request application, operable upon a processor of the AT or other devices) to ATs to initiate overlay RAT enable requests for providing service continuity. The RAT enable request application may utilize a performance factor, such as coverage by a RAT suitable for providing a requested service (albeit perhaps not presently available due to energy savings operation), for coordinating and controlling energy saving operation according to the concepts herein. In operation, the RAT enable request application may detect or otherwise be able to determine that in a given geographic region there is coverage provided by a RAT of the RAT specific service (e.g., overlay network coverage), although such coverage may presently be unavailable due to energy savings operation.

The RAT enable request application may have access to a database (e.g., stored locally by the AT and/or accessible through the network) providing information regarding geographic coverage of one or more RAT, services, network resources, etc. For example, the RAT enable request application of embodiments may have a local database that stores macro cell signatures in terms of underlay network coverage and whether overlay RAT coverage is available. At any time when overlay RAT is unavailable, the AT operating under control of the RAT enable request application may check the database using the currently detected underlay RAT cell signature to determine whether there is overlay RAT coverage for the current underlay network cell signature. If there is overlay RAT coverage, the AT knows that resources of the overlay network have been turned off for energy savings. If there is no overlay RAT coverage, the AT able to determine this. If there is no relevant database entry (e.g., no matching underlay cell signature), then it is the first time AT is in the area and the AT may utilize communications with or through the underlay RAT if it is to be determined whether there is overlay RAT coverage or whether overlay RAT is in energy savings mode.

When the overlay RAT is available, the RAT specific services would be accessed through the overlay RAT as normal. However, when the overlay RAT is not available due to inter-RAT energy savings, the RAT enable request application would recognize that the geographic area has the appropriate RAT associated therewith, but that the RAT is presently unavailable, and capture the request for the RAT specific service. Rather than presenting an error or otherwise failing to provide the requested service, the RAT enable request application initiates a process through which the overlay RAT is brought out of energy savings operation and the AT is provided the RAT specific service.

Operation according to aspects of the disclosure may make determinations in addition to the above mentioned determination that there is coverage provided by a RAT of the RAT specific service before making an overlay RAT enable request. For example, such an overlay RAT enable request may be reserved for ATs (or their associated users) of a particular type, for ATs having a particular QoS associated therewith, for ATs having particular premium services associated therewith, etc.

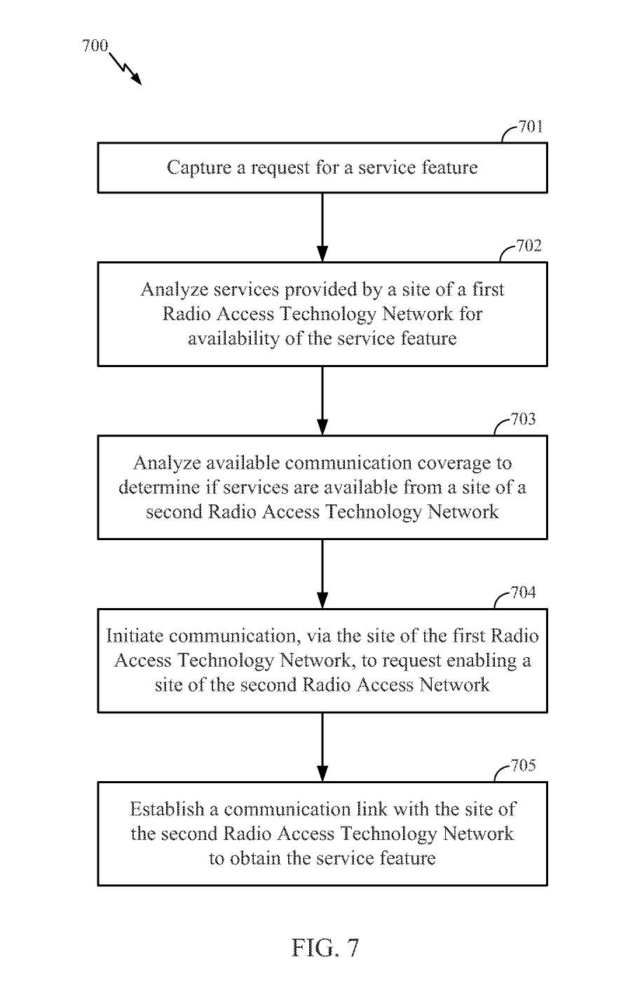

FIG. 7 shows a method operable at an AT for providing service continuity according to aspects of the present disclosure. Method 700 of FIG. 7 includes capturing a request for a service feature at block 701. Services provided by a radio access technology network site of a first radio access technology network are analyzed for availability of the service feature at block 702. At block 703 of method 700 available communication coverage is analyzed to determine if services are available from a radio access technology network site of a second radio access technology network. In accordance with aspects herein, an area of the communication coverage corresponds at least in part to an area of communication coverage of the radio access technology network site of the first radio access technology network. Communication is initiated, via the radio access technology network site of the first radio access technology network, to request enabling the radio access technology site of the second radio access technology network at block 704. At block 705 a communication link is established with the radio access technology network site of the second radio access technology network to obtain the service feature and provide continued communication services within a portion of a service area impacted by energy saving technique operation of the radio access technology network site of the second radio access technology network.

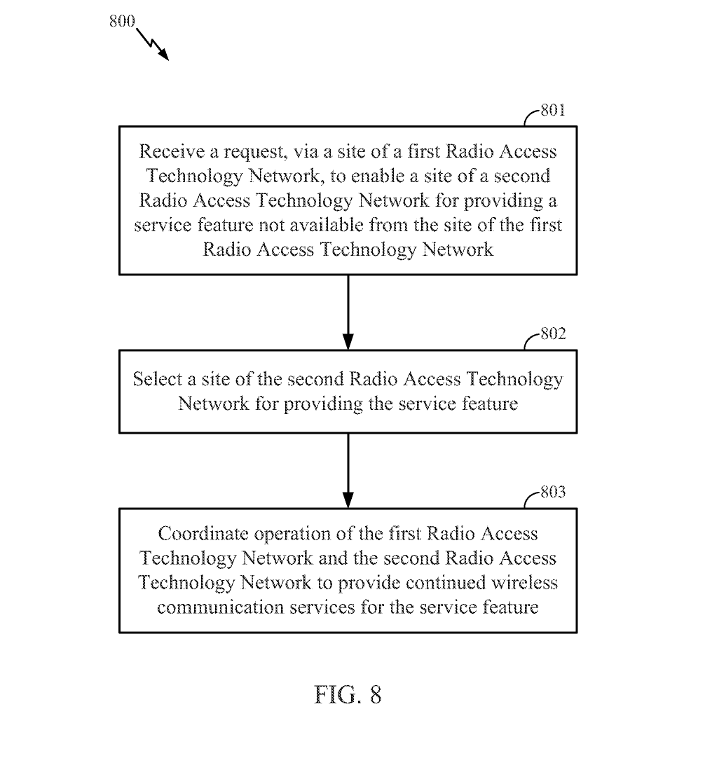

FIG. 8 shows a method operable at network energy savings intelligence for providing service continuity according to aspects of the present disclosure. Method 800 of FIG. 8 includes receiving, via a radio access technology site of a first radio access technology network, a request to enable a radio access technology site of a second radio access technology network for providing a service feature not available from the radio access technology site of the first radio access technology network at block 801. A radio access technology site of the second radio access technology network is selected for providing the service feature at block 802. Operation of the first radio access technology network and the second radio access technology network are coordinated at block 803 to provide the requested service feature, and thereby provide continuity of wireless communication services for the service feature despite the service feature having not been available within at least a portion of a communication coverage area of the radio access technology site of the second radio access technology network.

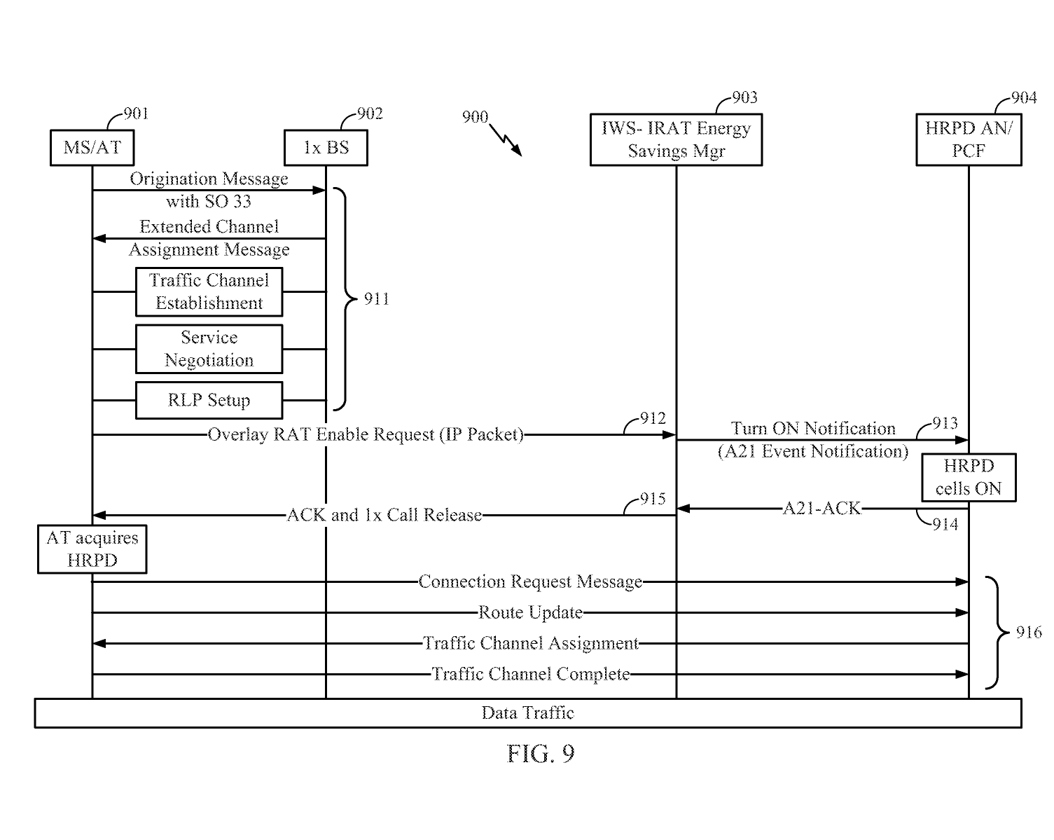

FIG. 9 shows call flow 900 implementing a RAT enable request application initiated process for facilitating continuity of service with respect to a RAT specific service. In the illustrated call flow, AT 901 is attempting to access a RAT specific service when disposed in a service area of BS 902 of a first RAT (e.g., as may correspond to cell 112 of underlay network 110) when a BS of a second RAT (e.g., cell 222 of overlay network 120) capable of providing the RAT specific service is in energy savings mode. Accordingly, the illustrated signaling between AT 901, BS 902 of the underlay network, Interworking Solution (IWS) 903, and access network/point coordination function (AN/PCF) 904 of the overlay network may be implemented to bring one or more resource of the overlay network out of energy savings operation. It should be appreciated that call flow 900 of FIG. 9 utilizes an existing air interface with the RAT enable request application and modifications at the IWS to facilitate continuity of service. Accordingly, continuity of service for a RAT specific service may be made available in a large number of legacy networks, without change to the air interface, using the techniques of the illustrated call flow.

In call flow 900 illustrated in FIG. 9, the RAT enable request application operating on AT 901 makes a packet switched (PS) data call on the underlay RAT when a request for a RAT specific service is made when AT 901 is disposed in a service area covered by an appropriate RAT currently operating in energy savings mode. Communication exchange 911 comprises a process for establishing a PS data link between AT 901 and BS 902 using a standard air interface of the underlay RAT. Once the PS data link is established, the RAT enable request application of AT 901 may send a PS data call (overlay RAT enable request 912) to IWS 903 requesting to turn ON appropriate overlay network resources for a desired RAT specific service. That is, the low rata PS data call contains the Overlay RAT Request packet according to the illustrated call flow. An application layer entity at IWS 903 (e.g., network energy savings intelligence) that manages/keeps track of which overlay network resources are and/or are not presently in energy savings mode, requests bringing the appropriate overlay network resources out of energy savings operation.

It should be appreciated that, although IWS 903 is illustrated as being separate from BS 902 and AN/PCF 904, IWS 903 may be collocated in BS 902, AN/PCF 904, and/or other devices of the network. IWS 903 may provide such functions as storing radio parameters utilized for CISCO Systems Network Architecture (C SNA) support, mapping underlay network pilot information and overlay network sector information into BTS Cell ID, providing the random number (RAND) used for authentication, etc. IWS 903 may additionally or alternatively be adapted to include network energy savings intelligence, or a portion thereof, (e.g., in the form of an instruction set operable upon a processor of IWS 903) for controlling network resources to provide energy savings operation as described herein. It should be appreciated that network energy savings intelligence, or portions thereof, providing operation as described herein, however, may be included within various devices of the network (e.g., BS 902, AN/PCF 904, etc.).

Although the use of IWS 903 is shown in call flow 900 illustrated in FIG. 9, aspects of the disclosure may utilize other devices/systems for providing the inter-RAT and/or network energy savings intelligence functionality. For example, an operations, administration, and maintenance (OA&M) entity may be configured to handle the overlay RAT enable requests herein.

In call flow 900 of FIG. 9, IWS 903 determines the appropriate resources of the overlay network to be brought out of energy savings operation and initiates messaging to AN/PCF 904 to cause the appropriate resources of the overlay network to be brought out of energy savings operation. For example, information regarding the position of AT 901, the location of BS 902 being accessed by AT 901, the particular RAT specific service being requested by AT 901, etc. may be utilized by network energy savings intelligence of IWS 903 to determine one or more resource of the overlay network to be brought out of energy savings operation. IWS 903 may utilize radio information, such as estimated one way delays, target cell identifiers, and/or pilot strength measurements, to determine overlay network resources to which AT 901 may be assigned. From AT provided underlay network pilot measurements, for example, IWS 903 can estimate the corresponding overlay network pilot measurements for known overlay network pilots. For example, in collocated overlay network and underlay network cells, the cells are likely transmitting from the same antenna mast and the overlay network values can be estimated to be very close to the underlay network values. In non-collocated overlay network and underlay network cells, IWS 903 may have information about relative distances between overlay network and underlay network cells (e.g., via provisioning).

Using information regarding the determination of the overlay network resources to be brought out of energy savings operation to provide RAT specific services to AT 901, IWS 903 provides signaling to AN/PCF 904 to cause the particular overlay network resources to be brought out of energy savings operation. Accordingly, turn ON notification 913 may be transmitted by IWS 903 to AN/PCF 904 requesting that particular overlay network resources be brought out of energy savings operation.

Messages, such as turn ON notification 913, may be communicated between IWS 903 and AN/PCF 904 (as well as other devices) using an A21 interface common to such inter-network connections. Such an interface provides inter-system communication between different RANs, such as those of the underlay network and the overlay network. IWS 903 provides an endpoint in the underlay network for the A21 interface between the two networks. A21-Event Notification messages may be sent by the entity at either end of the A21 interface to provide notification of some event that may be of interest to the entity at the other end of the A21 interface. The signaling protocol stack for the A21 interface typically comprises the following layers: IOS Application; UDP; IP; Link Layer; and Physical Layer.

When resources of the overlay network (e.g., one or more cell providing coverage of an area in which AT 901 is operating) are brought out of energy savings operation (e.g., turned on), an application layer acknowledgement (ACK) is returned to AT 901, as shown by ACK 914 and ACK 915. It should be appreciated that, having completed communication of the overlay RAT enable request, the PS data link may be torn down. Accordingly, ACK 915 provided to AT 901 by IWS 903 includes a PS call release message.

Having brought the appropriate resources of the overlay network out of energy savings operation, AT 901 may tune to the overlay network resources and initiate connection establishment procedures using the overlay network resources. For example, the communication exchange at 916 comprises a process for establishing a communication link between AT 901 and AN/PCF 904 using a standard air interface of the overlay RAT. Accordingly, the foregoing service continuity technique can be deployed without any changes to the communications standards, with some modification to the IWS to provide operation as described above and with modification of the ATs to include the RAT enable request application.

It should be appreciated from the foregoing that operation of the RAT enable request application at AT 901 captured the user's request for RAT specific services and, despite the overlay network resources for providing the RAT specific services having been in energy savings operation, AT 901 was provided the RAT specific services by operation of call flow 900. However, there is some latency associated with the operation to being the overlay network resources out of energy savings operation (e.g., latency associated with the call set up phase and the signaling to control the overlay network resources) as opposed to directly accessing resources of the overlay network when are available. For some applications, such as PSVT, this latency can be absorbed without impacting the user experience. However, for other applications, such as QChat, the latency is more noticeable by the user and thus may result in slight user experience degradation. The latency experienced through operation of call flow 900 is expected to be comparable to the latency associated with service redirection and better than inter-RAT handoff latency presently in use for other purposes, and thus is likely to provide an acceptable user experience.

Various adaptations may be provided to minimize or mitigate the above mentioned latency. For example, updated overlay network information (e.g., resource geographic mapping information, resource energy savings operation schedules, etc.) may be provided to the AT periodically to expedite overlay network resource acquisition. The RAT enable request application may, for example, be periodically provided with updated overlay network information and/or other updated information, such as using CDMA 1x short data burst communications, internet protocol (IP) datagrams, etc. The ACK message provided to the AT (e.g., ACK 915) may be adapted to contain the relevant overlay network resource information (e.g., the particular cells/channels to tune to). Such information may assist the AT in establishing communication links with the overlay network (e.g., decreasing searching and acquisition time), thereby decreasing latency.

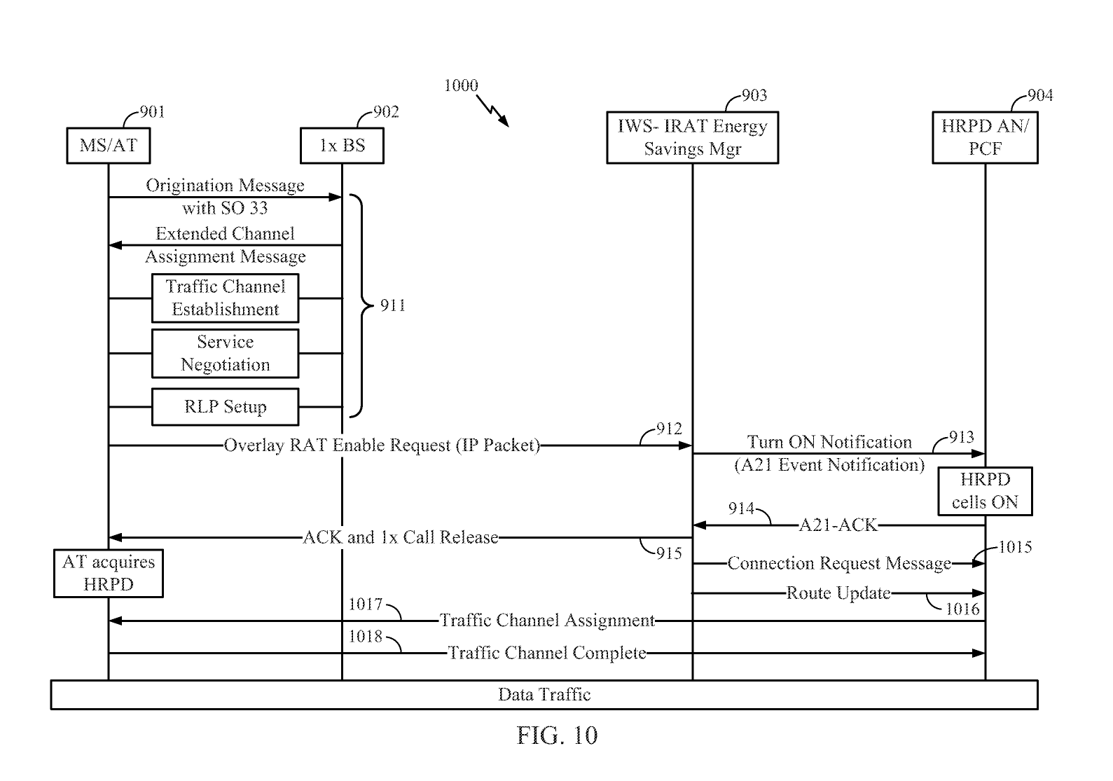

Directing attention to FIG. 10, call flow 1000 is shown implementing an enhanced RAT enable request application initiated process for facilitating continuity of service with respect to a RAT specific service. Call flow 1000 operates similar to that of call flow 900 discussed above, although call flow 1000 has been adapted to reduce latency. Specifically, in call flow 1000 illustrated in FIG. 10 rather than implementing the communication exchange (e.g., communication exchange 916 of FIG. 9) for establishing a communication link between AT 901 and AN/PCF 904 using a standard air interface of the overlay RAT, call flow 1000 utilizes network energy savings intelligence at IWS 903 to send the connection request to the overlay network on behalf of AT 901. For example, network energy savings intelligence in call flow 1000 may send connection request 1015 and route update 1016 to AN/PCF 904 with AT identity information, QoS information, etc. for setting up a connection between AT 901 and resources of the overlay network. Some or all of this information may be provided to IWS 903 in the PS call data from AT 901 and/or determined from information available to IWS 903. Thereafter, traffic channel assignment 1017 and/or other overlay network communication link information may be provided by the overlay RAT to AT 901. Using this information, AT 901 is enabled to establish the communication link using resources of the overlay network using traffic channel complete 1018.

It should be appreciated that the adaptation of call flow 1000 shown in FIG. 10 avoids the AT sending the connection request message to the overlay network. Therefore, operation of call flow 1000 expedites the connection of AT 901 to the overlay network resources. It is expected that the latency associated with the adaptations of call flow 1000 will reduced of that of call flow 900 to the point of being on the order of the latency associated with a mobile initiated Fast Connect on HRPD. However, the overlay network communication link protocol provided in call flow 1000 implements a change in the air interface (e.g., to provide the connection request by IWS 903 rather than AT 901), albeit a relatively small change that may be implemented without significant impact to remaining legacy protocols.

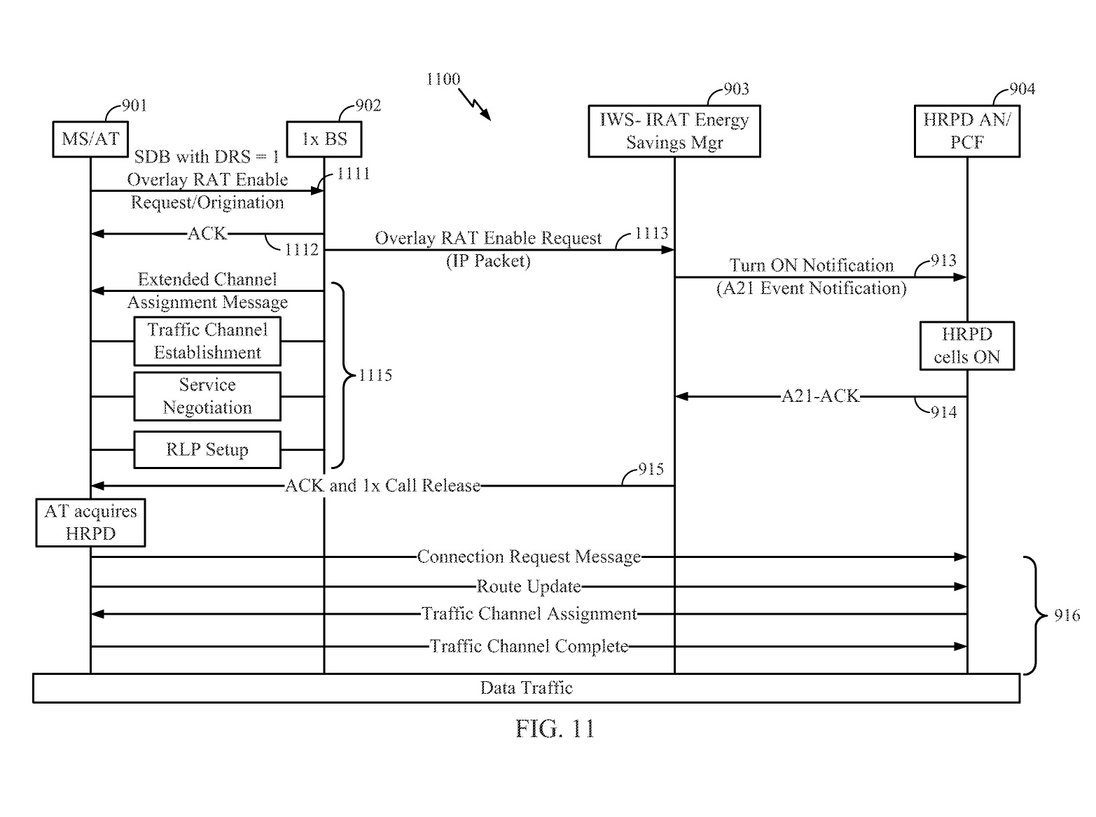

Call flow 1100 shown in FIG. 11 implements another enhanced RAT enable request application initiated process for facilitating continuity of service with respect to a RAT specific service. As with call flow 1000 above, call flow 1100 operates similar to that of call flow 900 discussed above and has been adapted to reduce latency. Specifically, in call flow 1100 illustrated in FIG. 11 rather than implementing communication exchange 911 for establishing a PS data link between AT 901 and BS 902 using a standard air interface, a short data burst (SDB) is used to initiate an overlay RAT enable request. For example, as shown in call flow 1100, AT 901 may communicate SDB 1111 to BS 902. SDB 1111 may contain little or no data (e.g., merely DRS=1 indicating data ready to send) and thus the overlay RAT enable request packet used in this technique may be relatively small. Moreover, not only the overlay RAT enable request packet, but other information, such as QoS, can be sent the AT as one or more short data burst. BS 902 may acknowledge receipt of the SDB with ACK 1112, such as may comprise a SDB. Rather than awaiting traffic channel establishment for communicating an overlay RAT enable request, BS 902 (e.g., network energy savings intelligence thereof) in call flow 1100 is adapted to interpret SDB 1111 as an overlay RAT enable request and thus send overlay RAT enable request 1113 to IWS 903 requesting to turn ON appropriate overlay network resources for a desired RAT specific service. Accordingly, turn ON notification 913 may be transmitted by IWS 903 to AN/PCF 904 and processing may proceed thereafter substantially as discussed with respect to call flow 900 above. Forms of data communication, such as IP datagrams, in addition to or in the alternative to the aforementioned SDBs may be utilized for signaling and/or communication according to embodiments herein.

It should be appreciated that in call flow 1100, although communication exchange 1115 for establishing a PS data link between AT 901 and BS 902 may be performed, the overlay RAT enable request was not delayed by this communication exchange. That is, a traffic channel need not be established between AT 901 and BS 902 for overlay RAT enable request 1113 to be communicated to IWS 903 in call flow 1100. Thus, latency associated with that communication exchange is avoided. Moreover, the overlay network communication link protocol provided in call flow 1100 may be implemented without change in the air interface between AT 901 and BS 902, although adaptation of BS 902 to identify the SDB as an overlay RAT enable request may be provided.

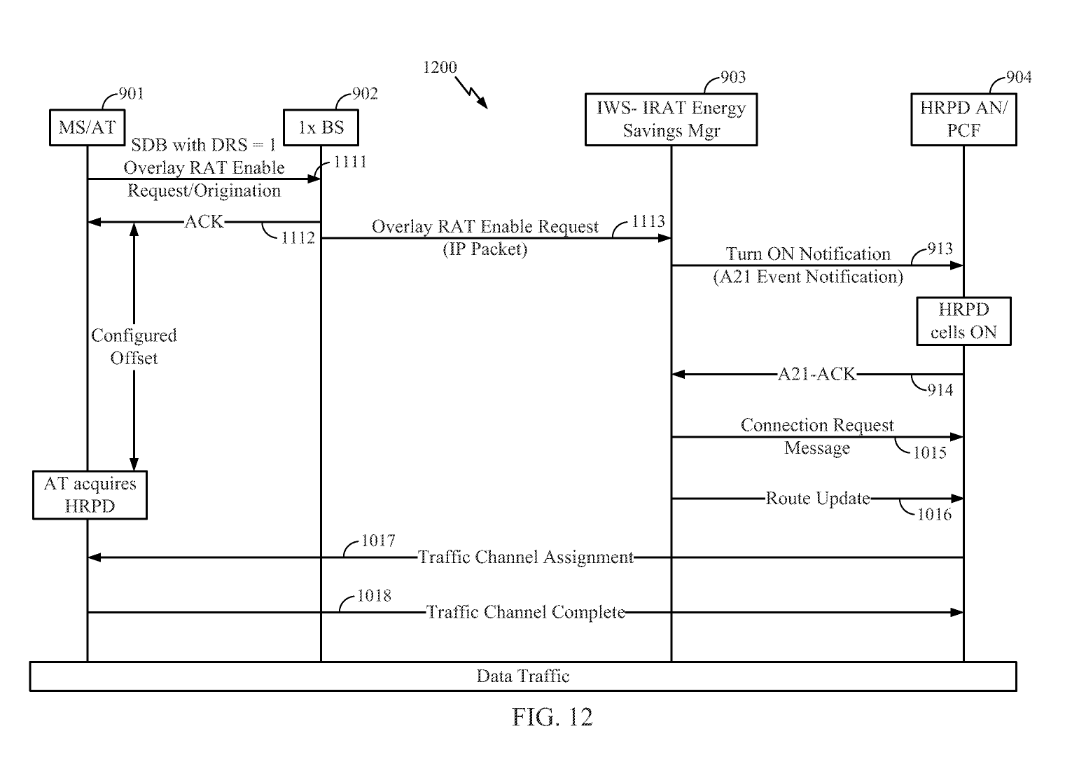

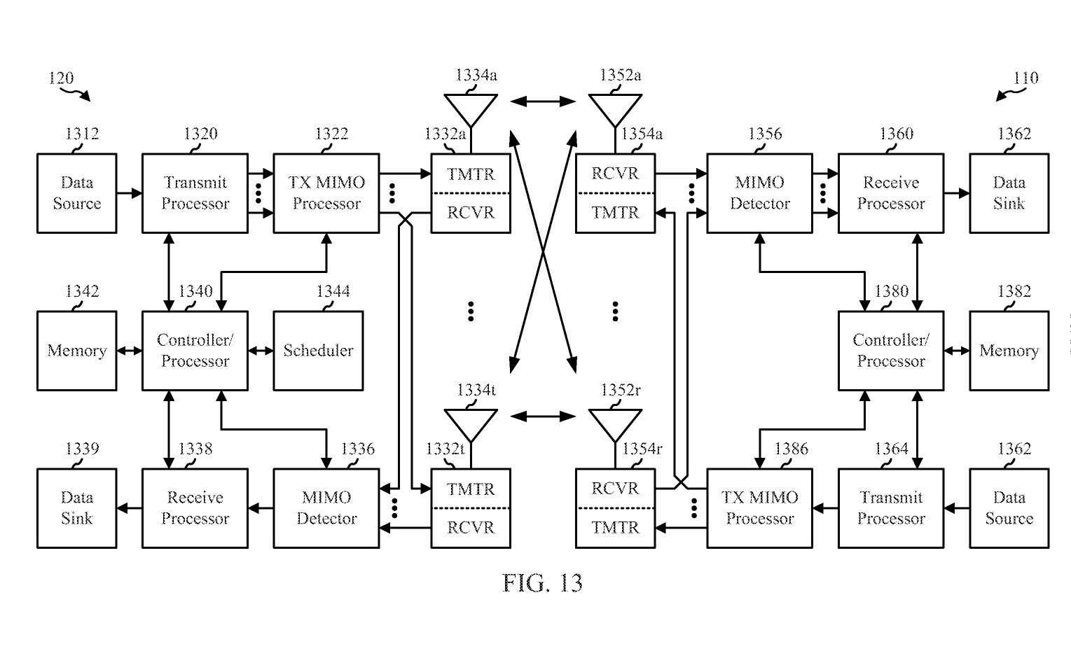

Call flow 1200 shown in FIG. 12 implements still another enhanced RAT enable request application initiated process for facilitating continuity of service with respect to a RAT specific service. Call flow 1200 implements the enhancements of both call flow 1000 and call flow 1100 into the baseline technique of call flow 900. Accordingly, call flow 1200 utilizes a short data burst (SDB) to initiate an overlay RAT enable request and, in response to the SDB message, network energy savings intelligence at IWS 903 sends the connection request to the overlay network on behalf of AT 901. By combining the foregoing techniques, call flow 1200 provides the best performance with respect to latency. However, call flow 1200 potentially implicates changes to the air interface or wireless communication standards.

It should be appreciated that the foregoing techniques are not limited to application in providing continuity of service when network resources are operated in energy savings mode. Operators are not likely to change their policies and allow particular services on the underlay RAT as there will be users trying to access those services in areas with underlay RAT only coverage. For example, in CDMA 1x+HRPD coverage, users accessing CDMA 1x for other applications (voice over CDMA 1x) can try to do simultaneous access of the premium services over CDMA 1x. In CDMA 1x+HRPD coverage, CMDA 1x only devices can request those services. Thus, the foregoing techniques provide a way of enabling service redirection indirectly for those applications that cannot be accessed over the underlay RAT.

Various aspects of the present disclosure, such as network energy savings intelligence and/or RAT enable request application, or portions thereof, may be implemented in software. When implemented in software, the aspects of the present disclosure are essentially code segments or program code to perform the necessary tasks. The code segments or program code can be stored in a computer readable medium. The “computer readable medium” may include any suitable medium that can store or transfer information. Examples of the computer readable medium include an electronic circuit, a semiconductor memory device, a random access memory (RAM), a read only memory (ROM), a flash memory, an erasable ROM (EROM), a magnetic disk, an optical disk, etc.

FIG. 13 shows a block diagram of a processor-based configuration of BS 1310 and AT 1320 suitable for executing code segments defining operation as described herein. BS 1310 may be equipped with antennas 1334a through 1334t and the AT 1320 may be equipped with antennas 1352a through 1352r, as shown.

At BS 1310, transmit processor 1320 may receive data from data source 1312 and control information from controller/processor 1340. The control information may be for the PBCH, PCFICH, PHICH, PDCCH, etc. The data may be for the PDSCH, etc. Transmit processor 1320 may process (e.g., encode and symbol map) the data and control information to obtain data symbols and control symbols, respectively. Transmit processor 1320 may also generate reference symbols, e.g., for the PSS, SSS, and cell-specific reference signal. A transmit (TX) multiple-input multiple-output (MIMO) processor 1330 may perform spatial processing (e.g., precoding) on the data symbols, the control symbols, and/or the reference symbols, if applicable, and may provide output symbol streams to the modulators (MODs) 1332a through 1332t. Each modulator 1332 may process a respective output symbol stream (e.g., for OFDM, etc.) to obtain an output sample stream. Each modulator 1332 may further process (e.g., convert to analog, amplify, filter, and upconvert) the output sample stream to obtain a downlink signal. Downlink signals from modulators 1332a through 1332t may be transmitted via the antennas 1334a through 1334t, respectively.

At AT 1320, antennas 1352a through 1352r may receive the downlink signals from BS 1310 and may provide received signals to the demodulators (DEMODs) 1354a through 1354r, respectively. Each demodulator 1354 may condition (e.g., filter, amplify, downconvert, and digitize) a respective received signal to obtain input samples. Each demodulator 1354 may further process the input samples (e.g., for OFDM, etc.) to obtain received symbols. A MIMO detector 1356 may obtain received symbols from all the demodulators 1354a through 1354r, perform MIMO detection on the received symbols if applicable, and provide detected symbols. A receive processor 1358 may process (e.g., demodulate, deinterleave, and decode) the detected symbols, provide decoded data for AT 1320 to a data sink 1360, and provide decoded control information to a controller/processor 1380.

On the uplink, at AT 1320, transmit processor 1364 may receive and process data (e.g., for the PUSCH) from data source 1362 and control information (e.g., for the PUCCH) from controller/processor 1380. Transmit processor 1364 may also generate reference symbols for a reference signal. The symbols from transmit processor 1364 may be precoded by TX MIMO processor 1366 if applicable, further processed by demodulators 1354a through 1354r (e.g., for SC-FDM, etc.), and transmitted to BS 1310. At BS 1310, the uplink signals from AT 1320 may be received by antennas 1334, processed by modulators 1332, detected by MIMO detector 1336 if applicable, and further processed by receive processor 1338 to obtain decoded data and control information sent by AT 1320. Processor 1338 may provide the decoded data to data sink 1339 and the decoded control information to controller/processor 1340.

Controllers/processors 1340 and 1380 may direct the operation at BS 1310 and the AT 1320, respectively. Controller/processor 1340 and/or other processors and modules at BS 1310 may perform or direct the execution of various processes for the techniques described herein. Controllers/processor 1380 and/or other processors and modules at AT 1320 may also perform or direct the execution of various processes for the techniques described herein. Accordingly, controller/processor 1340 may execute code segments of network energy savings intelligence for providing operation as described herein. Likewise, controller/processor 1380 may execute code segments of a RAT enable request application for providing operation as described herein. Memories 1342 and 1382 may store data and program codes for BS 1310 and AT 1320, respectively. Scheduler 1344 may schedule UEs for data transmission on the downlink and/or uplink.

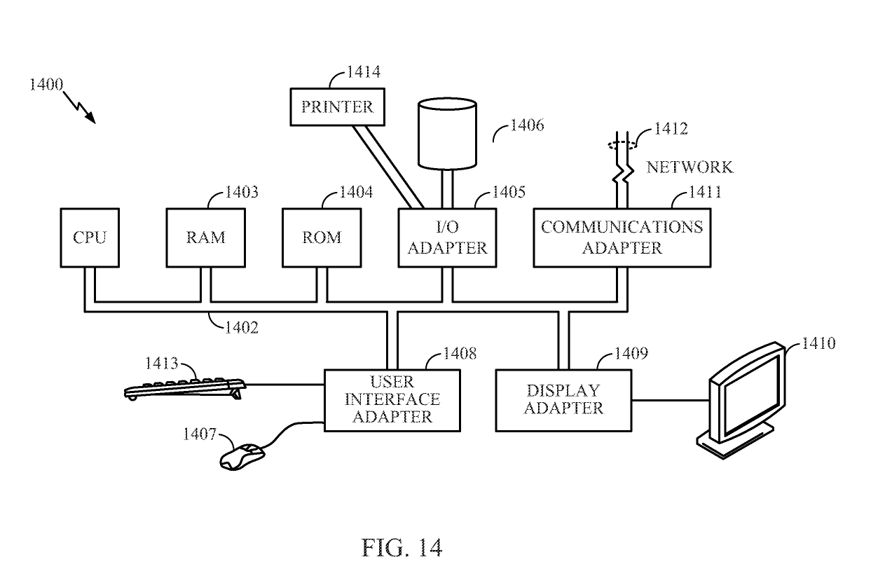

FIG. 14 illustrates processor-based system 1400 suitable for hosting and executing program code providing functions in accordance with aspects of the present disclosure. For example, processor-based system 1400 may be adapted to provide some or all of the functions of an IWS as described herein. Central processing unit (CPU) 1401 is coupled to system bus 1402. CPU 1401 may be any suitable general purpose CPU, such as an Intel PENTIUM or CORE processor. However, the present disclosure is not restricted by the architecture of CPU 1401 as long as CPU 1401 supports the inventive operations as described herein. Bus 1402 is coupled to RAM 1403, which may comprise SRAM, DRAM, SDRAM, etc. ROM 1404 is also coupled to bus 1402, which may comprise PROM, EPROM, EEPROM, etc. RAM 1403 and ROM 1404 store user and system data, program code, and the like.

Bus 1402 is also coupled to input/output (I/O) controller 1405, communications adapter 1411, user interface 1408, and display adapter 1409. I/O adapter 1405 connects storage devices 1406, such as may comprise one or more of magnetic disk, optical disk, etc., to the processor-based system. I/O adapter 1405 is also connected to printer 1414, which would allow the system to output hard copies of information. Communications adaptor 1411 is adapted to couple processor-based system 1400 to network 1412, which may be one or more of a telephone network, a wireless network, a local (LAN) and/or a wide-area (WAN) network, an Ethernet network, the Internet network. User interface 1408 couples user interface devices, such as keyboard 1413 and pointing device 1407, to processor-based system 1400. Display adaptor 1409 is driven by CPU 1401 to control the display on display device 1410.

Although aspects of the present disclosure and their advantages have been described in detail, it should be understood that various changes, substitutions and alterations can be made herein without departing from the spirit and scope of the disclosure and as encompassed by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the concepts herein. Accordingly, the appended claims are intended to include within their scope such processes, machines, manufacture, compositions of matter, means, methods, or steps.

What is claimed is:

1. A method comprising:
analyzing a performance factor of one or more radio access technology network site, wherein the one or more radio access technology network site is selected from the group consisting of radio access technology network sites of a plurality of sites of a first radio access technology network and radio access technology network sites of a plurality of sites of a second radio access technology network;
selecting a site of the second radio access technology network as a function of the analyzing for altering operation in accordance with an energy saving technique; and
coordinating operation of the first radio access technology network and the second radio access technology network to provide continued wireless communication services within a portion of a service area impacted by energy saving technique operation alteration of the selected second radio access technology network site.

2. The method of claim 1, wherein the coordinating operation of the first radio access technology network and the second radio access technology network comprises:
altering operation of the selected site to place the selected site in energy savings operation according to the energy savings technique; and
operating one or more sites of the second radio access technology network to provide continued wireless communication services with respect to a coverage gap in the second radio access technology network resulting from the energy savings operation of the selected site.

3. The method of claim 1, wherein the coordinating operation of the first radio access technology network and the second radio access technology network comprises:
altering operation of the selected site to place the selected site in energy savings operation according to the energy savings technique;
manipulating the resource of the at least one site of the second radio access technology network; and
operating one or more sites of the first radio access technology network to provide continued wireless communication services with respect to a gap in coverage in the second radio access technology network resulting from the energy savings operation of the selected site and which remains after the resource manipulation of the at least one site of the second radio access technology.

4. The method of claim 1, wherein the coordinating operation of the first radio access technology network and the second radio access technology network comprises:
capturing the request for the service not directly available through the first radio access technology network;
altering operation of the selected site to bring the selected site out of energy savings operation according to the energy savings technique;
coordinating initiation of the service by the second radio access technology network using the selected site.

5. A method comprising:
analyzing a performance factor of at least one radio access technology network site, wherein the at least one radio access technology network site is selected from the group consisting of one or more radio access technology network sites of a first radio access technology network and one or more radio access technology network sites of a second radio access technology network;
selecting a site of the second radio access technology network as a function of the analyzing for altering operation in accordance with an energy saving technique;
implementing an energy saving technique at the selected site of the second radio access technology network to place a resource of the selected site in energy savings mode; and
coordinating operation of the first radio access technology network and the second radio access technology network to serve an area of the second radio access technology network impacted by implementation of the energy savings mode.

6. The method of claim 5, wherein the performance factor comprises a type of resource of the one of the selected second radio access technology network site.

7. The method of claim 5, wherein the performance factor comprises performance of one or more wireless communication network resource remaining after implementation of the energy saving technique operation alteration.

8. The method of claim 7, wherein the coordinating operation of the first radio access technology network and the second radio access technology network comprises:
operating one or more sites of the first radio access technology network to provide continued wireless communication services with respect to a gap in coverage resulting from the energy savings operation of the selected site of the second radio access technology network.

9. The method of claim 7, wherein the performance of the one or more wireless communication network resource remaining after implementation of the energy saving technique comprises performance of sites of the second radio access technology network other than the selected second radio access technology network site.

10. The method of claim 7, wherein the performance of the one or more wireless communication network resource remaining after implementation of the energy saving technique comprises performance of sites of the first radio access technology network.

11. The method of claim 1, wherein the coordinating operation of the first radio access technology network and the second radio access technology network comprises:
manipulating a resource of the at least one site of the second radio access technology network; and
operating one or more sites of the first radio access technology network to provide continued wireless communication services with respect to a gap in coverage in the second radio access technology network resulting from the energy savings operation of the selected site and which remains after the resource manipulation of the at least one site of the second radio access technology.

12. The method of claim 11, wherein the manipulation of the resource comprises:
adjusting an antenna system of the at least one site of the second radio access technology network.

13. The method of claim 11, wherein the manipulation of the resource comprises:
adjusting a data rate of one or more overhead channel of the at least one of a site of the second radio access technology network.

14. The method of claim 11, wherein the manipulation of the resource comprises:
adjusting a frequency reuse pattern of the at least one of a site of the second radio access technology network.

15. A system comprising:
network energy savings intelligence in communication with one or more radio access technology network sites of a first radio access technology network and one or more radio access technology network sites of a second radio access technology network, the network energy savings intelligence being operable to analyze a performance factor of at least one radio access technology network site, to select a site of the second radio access technology network as a function of the analyzing for altering operation in accordance with an energy saving technique, and to coordinate operation of the first radio access technology network and the second radio access technology network to serve an area of the second radio access technology network impacted by implementation of the energy savings technique.

16. The system of claim 15, further comprising:
a database providing information regarding resource type information adapted for use in determining if a particular resource is a suitable candidate for implementing one or more feature of the energy savings technique, wherein the performance factor comprises the resource type information of the one of the selected second radio access technology network site.

17. The system of claim 15, further comprising:
a database providing historical traffic pattern information adapted for use in determining if a particular resource is a suitable candidate for implementing one or more feature of the energy savings technique, wherein the performance factor comprises a historical traffic load experienced by the one or more radio access technology network site.

18. The system of claim 15, wherein the network energy savings intelligence comprises:
logic operable to analyze current traffic volume metrics regarding resources of one or more radio access technology network site of at least one of the first radio access technology network and the second radio access technology network, wherein the performance factor comprises a current traffic load experienced by the one or more radio access technology network site.

19. The system of claim 15, wherein the network energy savings intelligence comprises:
logic operable to predict one or more traffic volume metric regarding resources of one or more radio access technology network site of at least one of the first radio access technology network and the second radio access technology network, wherein the performance factor comprises traffic load predicted to be experienced by the one or more radio access technology network site.

20. The system of claim 15, wherein the network energy savings intelligence comprises:
logic operable to analyze one or more resource of one or more radio access technology network site of at least one of the first radio access technology network and the second radio access technology network, wherein the performance factor comprises performance of at least one of the one or more wireless communication network resource remaining after implementation of the energy saving technique.

21. The system of claim 15, wherein the network energy savings intelligence comprises:
logic operable to control an antenna system of one or more radio access technology network site of at least one of the first radio access technology network and the second radio access technology network to adjust communication coverage in association with implementing the energy savings technique, wherein the performance factor comprises resulting coverage to be provided by manipulation of the antenna system.

22. The system of claim 15, wherein the network energy savings intelligence comprises:
logic operable to control a data rate of one or more overhead channel of the at least one of a site of the second radio access technology network.

23. The system of claim 15, wherein the network energy savings intelligence comprises:
logic operable to adjust a frequency reuse pattern of the at least one of a site of the second radio access technology network.

24. A system comprising:
means, in communication with a radio access technology network site of at least one of a first radio access technology network and a second radio access technology network, for analyzing a performance factor of at least one radio access technology network site;
means for selecting a site of the second radio access technology network as a function of the analyzing for altering operation in accordance with an energy saving technique; and
means, in communication with one or more radio access technology network sites of the first radio access technology network and one or more radio access technology network sites of the second radio access technology network, for coordinating operation of the first radio access technology network and the second radio access technology network to serve an area of the second radio access technology network impacted by implementation of the energy savings technique.

25. A computer program product for wireless communications in a wireless network, comprising:
a computer-readable medium having program code recorded thereon, said program code comprising:
program code to analyze a performance factor of at least one radio access technology network site, wherein the at least one radio access technology network site is selected from the group consisting of one or more radio access technology network sites of a first radio access technology network and one or more radio access technology network sites of a second radio access technology network;
program code to select a site of the second radio access technology network as a function of the analyzing for altering operation in accordance with an energy saving technique;
program code to initiate implementation of an energy saving technique at the selected site of the second radio access technology network to place a resource of the selected site in energy savings mode; and
program code to coordinate operation of the first radio access technology network and the second radio access technology network to serve an area of the second radio access technology network impacted by implementation of the energy savings mode.

26. A method comprising:
capturing a request for a service feature;
analyzing services provided by a radio access technology network site of a first radio access technology network for availability of the service feature;
analyzing available communication coverage to determine if services are available from a radio access technology network site of a second radio access technology network, wherein an area of the communication coverage corresponds at least in part to an area of communication coverage of the radio access technology network site of the first radio access technology network;
initiating communication via the radio access technology network site of the first radio access technology network to request enabling the radio access technology site of the second radio access technology network; and
establishing a communication link with the radio access technology network site of the second radio access technology network to obtain the service feature and provide continued communication services within a portion of a service area impacted by energy saving technique operation of the radio access technology network site of the second radio access technology network.

27. The method of claim 26, wherein the initiating communication via the radio access technology network site of the first radio access technology network comprises:
using an air interface of the first radio access technology network which has not been adapted to accommodate the request to enable the radio access technology site of the second radio access technology network.

28. The method of claim 27, wherein the establishing the communication link with the radio access technology network site of the second radio access technology network comprises:
using an air interface of the second radio access technology network which has not been adapted to accommodate providing the continued communication services.

29. The method of claim 27, wherein the establishing the communication link with the radio access technology network site of the second radio access technology network comprises:
providing information in a message initiating the communication via the radio access technology network site of the first radio access technology network to expedite enabling the radio access technology site of the second radio access technology network.

30. The method of claim 26, wherein the initiating communication via the radio access technology network site of the first radio access technology network comprises:
using a short data burst to initiate an enable request.

31. The method of claim 26, wherein the initiating communication via the radio access technology network site of the first radio access technology network comprises:
using an IP datagram to initiate an enable request.

32. The method of claim 30, wherein the establishing the communication link with the radio access technology network site of the second radio access technology network comprises:
using an air interface of the second radio access technology network which has not been adapted to accommodate providing the continued communication services.

33. The method of claim 30, wherein the establishing the communication link with the radio access technology network site of the second radio access technology network comprises:
providing information in a message initiating the communication via the radio access technology network site of the first radio access technology network to expedite enabling the radio access technology site of the second radio access technology network.

34. A method comprising:
receiving, via a radio access technology site of a first radio access technology network, a request to enable a radio access technology site of a second radio access technology network for providing a service feature not available from the radio access technology site of the first radio access technology network;
selecting a radio access technology site of the second radio access technology network for providing the service feature; and
coordinating operation of the first radio access technology network and the second radio access technology network to provide continued wireless communication services for the service feature within at least a portion of a communication coverage area of the radio access technology site of the second radio access technology network.

35. The method of claim 34, further comprising:
pushing an instruction set to access terminals, the instruction set comprising logic operable to initiate the request to enable the radio access technology site of the second radio access technology network upon capturing a request for the service feature.

36. A system comprising:
an instruction set operable upon a wireless communication system access terminal to capture a request for a service feature, initiate a determination regarding the requested service being provided by a radio access technology network site of a first radio access technology network, initiate a determination regarding communication coverage by a radio access technology network site of a second radio access technology network, wherein an area of the communication coverage corresponds at least in part to an area of communication coverage of the radio access technology network site of the first radio access technology network, initiate communication via the radio access technology network site of the first radio access technology network to request enabling the radio access technology site of the second radio access technology network, and initiate establishing a communication link with the radio access technology network site of the second radio access technology network to obtain the service feature and provide continued communication services within a portion of a service area impacted by energy saving technique operation of the radio access technology network site of the second radio access technology network.

37. A system comprising:
network energy savings intelligence operable to receive, via a radio access technology site of a first radio access technology network, a request to enable a radio access technology site of a second radio access technology network for providing a service feature not available from the radio access technology site of the first radio access technology network, select a radio access technology site of the second radio access technology network for providing the service feature, and coordinate operation of the first radio access technology network and the second radio access technology network to provide continued wireless communication services for the service feature within at least a portion of a communication coverage area of the radio access technology site of the second radio access technology network.

38. The system of claim 37, wherein the network energy savings intelligence is further operable to analyze information regarding communication coverage provided by the selected radio access technology site of the second radio access technology network when selecting the radio access technology site of the second radio access technology network.

39. The system of claim 37, wherein the network energy savings intelligence is further operable to facilitate establishing a communication link with the radio access technology network site of the second radio access technology network using an air interface of the second radio access technology network which has not been adapted to accommodate providing the continued communication services when coordinating operation of the first radio access technology network and the second radio access technology network.

40. The system of claim 37, wherein the network energy savings intelligence is further operable to facilitate establishing a communication link with the radio access technology network site of the second radio access technology network using information received in the request to enable the radio access technology site of the second radio access technology network to expedite enabling the radio access technology site of the second radio access technology network when coordinating operation of the first radio access technology network and the second radio access technology network.
